(19) United States
(12) Patent Application Publication
(10) Pub. No.: US 2026/0039460 A1
(43) Pub. Date: Feb. 5, 2026

(54) METHOD AND SYSTEM FOR LENTICULAR ARRAY SETUP AND LENTICULAR KEY PRODUCTION

(71) Applicants: RODRIGO GOMEZ CLAROS, MURFREESBORO, TN (US); DANIEL ANTHONY REGAN, Derby, NY (US); KEVIN ANTHONY PEZZINO, AMHERST, NY (US)

(72) Inventors: RODRIGO GOMEZ CLAROS, MURFREESBORO, TN (US); DANIEL ANTHONY REGAN, Derby, NY (US); KEVIN ANTHONY PEZZINO, AMHERST, NY (US)

(21) Appl. No.: 19/289,068

(22) Filed: Aug. 3, 2025

Related U.S. Application Data
(60) Provisional application No. 63/679,074, filed on Aug. 2, 2024.

(51) Int. Cl. H04L 9/08; G02B 3/00; H04N 13/161; H04N 13/305

(52) U.S. Cl. CPC H04L 9/0866; G02B 3/0056; H04N 13/161; H04N 13/305; H04L 2209/805

(57) ABSTRACT

A system and method are disclosed for generating a substantially non-replicable lenticular key, by configuring a lenticular array to capture multi-angle optical data from a target. The lenticular array is positioned at a defined distance in front of the target, an aiming objective is chosen, and the image receptor and array support are aligned relative to the aiming objective. At least two lenticules from the lenticular array are used along with a digital layout to ensure lenticule alignment between the image receptor and the target. The lenticular array may be spatially rotated using a mobility mechanism to optimize angular orientation. A light source is provided to illuminate the target, and the system may incorporate various sensors and/or filters such as RGB-alpha, ultraviolet, infrared, or others. This configuration enables precise optical path control and supports the generation of codified lenticular keys for imaging, authentication, or data processing applications.

### CROSS REFERENCE TO RELATED APPLICATION

This application claims the benefit of United States Provisional Application of first-named inventor RODRIGO GOMEZ CLAROS, application No. 63/679,074, filed Aug. 2, 2024, having the title for Lenticular Keys, which is incorporated herein by reference in its entirety.

### FIELD OF THE INVENTION

The present disclosure relates to optical imaging systems, and more particularly to methods and systems for setting up and utilizing lenticular arrays for capturing and processing images to generate unique lenticular keys based on optical characteristics of objects or subjects.

### BACKGROUND

Lenticular lenses are optical structures comprising one or more lenses arranged to modify incident light rays through refraction and/or reflection. These lenses are configured to divert or focus light in a controlled manner, enabling a range of optical effects including color transitions, depth perception, and directional light control. Lenticular technology has found utility across multiple industries, including eyewear, automotive, and emerging digital applications. In the eyewear industry, lenticular lenses are employed to fabricate corrective lens systems for visually impaired individuals. High-powered lenticular lenses can be incorporated over smaller regions of standard-sized lenses, thereby enhancing refractive capability while minimizing lens thickness for wearability. The configuration enables precise redirection of light rays through specific areas of the lens to improve focal clarity and facilitate vision correction.

In automotive applications, lenticular lenses are used in headlight systems to redirect and focus emitted light, increasing illumination efficiency and coverage. These lenses enable controlled light dispersion from compact lighting units, improving visibility and safety under various driving conditions.

In augmented reality (AR), prior art discloses the integration of lenticular lens arrays with image markers to enhance detection and interpretation by camera systems. For example, U.S. Patent Publication No. US20200184732A1 describes lenticular sheets that present image patterns for AR applications. U.S. Patent Publication No. US20210375058A1 similarly demonstrates the use of lenticular lenses to modify marker patterns detectable by sensors, positioning lenticular structures between image surfaces and optical detection hardware.

Additional prior art illustrates the use of lenticular arrays comprising a plurality of lenticules for generating multidimensional and autostereoscopic visual displays. These arrays, often implemented as cylindrical lenses or barrier strips, have been positioned between viewers and pixel arrays to create composite and 3D effects. Digitized image compositions, corrected for pseudoscopic distortion, have been displayed using lenticular screens and processed for video output or print media.

Other known systems leverage lenticular screens to encode linear positional data by transmitting collimated radiation beams through lenticular sheets, allowing sensors to track relative displacement between layers. Flexible lenticular lenses have also been utilized to produce cylindrical 3D visuals through optical exposure techniques involving film strips.

Despite advancements, lenticular technology offers limited solutions to applications of light refraction and little to no solutions on implementing lenticular arrays capable of reliably transferring light and visual data for capturing and processing of markers under variable lighting and sensor conditions. Thus, there remains an unresolved need for an integrated lenticular system capable of dynamically capturing and codifying unique diverse optical markers under varying lighting, photo transferring, and sensor conditions. Prior applications have not used the attributes of lenticular technology in multi-marker detection in time, and the technology is applied often with limited adaptability across use cases. The instant disclosure addresses these shortcomings by introducing a lenticular array configuration designed to generate distinct optical keys from a physical source, enhance detection fidelity in a multi-marker process, and enable reliable marker identification in real-time applications.

### SUMMARY

Although illustrative embodiments of one or more aspects are provided herein, the disclosed processes may be implemented using any number of techniques. The disclosure is not limited to the illustrative or specific embodiments, any drawings, and any techniques illustrated herein, including any exemplary designs and embodiments illustrated and described herein, and may be modified within the scope of the appended claims along with their full scope of equivalents.

The present disclosure relates to a system and method are disclosed for generating a substantially non-replicable lenticular key, by configuring a lenticular array to capture multi-angle optical data from a target. The lenticular array is positioned at a defined distance in front of the target, an aiming objective is chosen, and the image receptor and array support are aligned relative to the aiming objective. At least two lenticules from the lenticular array are used along with a digital layout to ensure lenticule alignment between the image receptor and the target. The lenticular array may be spatially rotated using a mobility mechanism to optimize angular orientation. A light source is provided to illuminate the target, and the system may incorporate various sensors and/or filters such as RGB-alpha, ultraviolet, infrared, or others. This configuration enables precise optical path control and supports the generation of codified lenticular keys for imaging, authentication, or data processing applications.

The present disclosure further relates to methods and systems for lenticular codification that provide unique identification capabilities through the combination of lenticular lens arrays, digital markers, and image processing and addresses the need for codification of digital markers on subjects or objects by utilizing specialized lenticular arrays and image processing techniques, and data processing strategies to generate unique lenticular keys. The current disclosure uses the functionality and features of lenticular lenses while organizing them in ways that become a new physical apparatus. Lenticules are used to codify optical information when positioned between an object/subject marker and a camera, sensor, or any other capturing device. The lenticular lens is presented as an array of lenticules characterized by many predetermined attributes that offer innumerable ways to codify visual markers.

In one aspect, the present disclosure provides a method for setting up a lenticular array that includes setting up the array at a specific distance in front of an object/subject, selecting an aiming objective for detection by an image receptor, and positioning the image receptor and lenticular array support in relation to the selected aiming objective. The method further involves selecting appropriate lenticules, determining a layout for the lenticular array resulting in single or multiple arrays with individual lenticule alignment and focal distance, determining a mobility mechanism that allows movement of the lenticular array in XYZ axes, positioning a lighting setup for each aiming objective, and setting up various sensors including but not limited to RGB alpha, ultraviolet-capable, and infrared-capable sensors to capture the light data information within a time range.

According to another aspect of the present disclosure, a method for producing a lenticular key is provided that includes capturing a plurality of key markers using an image receptor through a lenticular/lens array and various sensors. The method involves organizing digitally and detecting generated image sequences, including determining movement vectors, codifying pixels using frame sequences in ON and OFF positions, organizing pixel data in rows and columns, and maintaining a data organization table. The method further includes digitally detecting silhouetted backlit markers associated with the object/subject, digitally layering the detected key markers, and organizing lenticular key data for delivery based on usage and need.

According to another aspect of the present disclosure, a lenticular array system is provided comprising an object/subject having a plurality of markers, an image receptor placed in front of the object/subject, and a lenticular/lens array positioned between them. The lenticular/lens array combines optical lenses organized in a specific order to provide a unique and non-replicable representation of the object/marker, supported by a grid that ensures proper alignment and supports mobility mechanisms. The system includes a backend image processing assembly that processes captured images to generate a unique lenticular key based on the optical characteristics of the marker/subject, using pixel codification and storage modules to track markers using a vector approach.

According to another aspect of the present disclosure, a lenticular codification system is provided comprising a target as a subject and/or object, a lenticular key as a device for codification of the target, and an array of lenticules arranged as the physical manifestation of the lenticular key. The lenticular key enables capturing of multiple images of the target through the array of lenticules in layers to provide proper optics and photographic information.

Another aspect of the disclosure is to provide for the codification of digital markers on a subject or an object.

The system and method enables new and unique programming opportunities in image and video processing fields while providing significant flexibility in lens structure and organization that alters the characteristics of capturable images. The system allows for obtaining codified results from visual markers and creates unique identification capabilities through the combination of lenticular lens arrays, digital markers, and image processing over time.

Further areas of applicability will become apparent from the description provided herein. It should be understood that the description and specific examples are intended for purposes of illustration only and are not intended to limit the scope of the present disclosure.

The present disclosure has been made in view of the above-mentioned circumstances, and has an object to provide lenticular keys comprising a lenticular lens array, at least one optical marker, and an image processing module. The embodiments disclosed in this application to achieve the above-mentioned object has various aspects, and the representative aspects are outlined as follows. With parenthetical reference to the corresponding parts, portions or surfaces of the disclosed embodiment, merely for the purposes of illustration and not by way of limitation, the present disclosure provides a general framework for describing a variety of lenticular keys having numerous deployment options and potential practical applications.

### BRIEF DESCRIPTION OF THE DRAWINGS

The present disclosure and the manner in which it may be practiced is further illustrated with reference to the accompanying drawings wherein:

FIG. 1 is an illustration of a schematic diagram showing the primary components for lenticular key codification, namely a subject/object, a lenticular array, and a key marker, according to one embodiment of the present disclosure.

FIG. 2A illustrates a top view of a lenticular array and image sensor layout, according to one embodiment of the present disclosure.

FIG. 2B shows a perspective three-dimensional representation of the lenticular array with multiple lenticules organized in a grid-like structure, according to one embodiment of the present disclosure

FIGS. 3A-J illustrate several reference layouts for lenticular arrays, according to one embodiment of the present disclosure.

FIG. 4A illustrates a top view of a schematic diagram of a fan-shaped arrangement of a lenticular array and image sensor according to one embodiment of the present disclosure.

FIG. 4B illustrates a schematic diagram of an alternative angular configuration of the lenticular array in relation to an image sensor according to one embodiment of the present disclosure.

FIGS. 5A-D illustrates several structural diagrams of individual lenticules structures and their mobility within the lenticule's configuration, according to embodiments of the present disclosure.

FIG. 6A-C illustrates options for possible mobility of individual lenticules within a lenticular array configuration, according to one embodiment of the present disclosure.

FIG. 7A illustrates a lenticular array configuration utilizing converging and diverging lenticules, according to one embodiment of the present disclosure.

FIG. 7B illustrates an example of an individual key marker produced utilizing converging and diverging lenticules, according to one embodiment of the present disclosure.

FIG. 8A illustrates a lenticular array configuration utilizing converging and flat lenticules, according to one embodiment of the present disclosure.

FIG. 8B illustrates an example of an individual key marker produced using a converging lenticule, according to one embodiment of the present disclosure.

FIG. 9A illustrates a lenticular array configuration utilizing a diverging lenticule, according to one embodiment of the present disclosure.

FIG. 9B illustrates an individual key marker produced using a diverging lenticule, according to one embodiment of the present disclosure.

FIG. 10A illustrates a lenticular array configuration utilizing a mirror lenticule, according to one embodiment of the present disclosure.

FIG. 10B illustrates an individual key marker produced using a mirror lenticule, according to one embodiment of the present disclosure.

FIG. 11A illustrates a lenticular array configuration utilizing polarized and non-polarized lenticules as light source modifier, and optical refraction device.

FIG. 11B illustrates an example of a key marker that may be produced utilizing polarized lenticules.

FIG. 11C illustrates an example of a key marker that may be produced utilizing non-polarized lenticules, according to one embodiment of the present disclosure.

FIG. 12 A illustrates a lenticular array configuration utilizing colored (or color-filtered) Lenticules, according to one embodiment of the present disclosure.

FIG. 12B illustrates examples of key markers produced using Red, Green and Blue RGB separation (or color-filtered) lenticules, according to one embodiment of the present disclosure.

FIG. 13A illustrates a lenticular array configuration utilizing an irregular or distorted lenticule, according to one embodiment of the present disclosure.

FIG. 13B illustrates an irregular or distorted lenticule, according to one embodiment of the present disclosure.

FIG. 13C illustrates an irregular or distorted lenticule structural grid, according to one embodiment of the present disclosure.

FIG. 13D illustrates a key marker produced using an irregular or distorted lenticule, according to one embodiment of the present disclosure.

FIG. 14A illustrates a lenticular array configuration utilizing an array of converging, flat and diverging lenticules, applied to a long working distance target and a long focal length according to one embodiment of the present disclosure.

FIG. 14B illustrates an example of a key marker produced using an array of converging, flat and diverging lenticules, according to one embodiment of the present disclosure.

FIG. 15A illustrates a lenticular array configuration utilizing close-up views applied to a close-up object/subject and a short focal length, according to one embodiment of the present disclosure.

FIG. 15B illustrates a key marker produced with a lenticular array configured for close-up views, according to one embodiment of the present disclosure.

FIG. 16A illustrates a lenticular array configuration utilizing an array of perpendicular and parallel polarized lenses, according to one embodiment of the present disclosure.

FIG. 16B illustrates an example of a key marker produced with a lenticular array of perpendicular and parallel polarized lenses, according to one embodiment of the present disclosure.

FIG. 16C illustrates an example of a key marker produced with a lenticular array of non-polarized lenses, according to one embodiment of the present disclosure.

FIG. 16D illustrates an example of a parallel polarized lenticular array, according to one embodiment of the present disclosure.

FIG. 16E illustrates a key marker generated using a parallel polarized lenticular array, according to one embodiment of the present disclosure.

FIG. 17A illustrates a lenticular array configuration utilizing alternative types of polarized lenses, including vertical and horizontal lenticules positioned between the light source and the object or subject, and between the object or subject and the image sensor, according to one embodiment of the present disclosure.

FIG. 17B depicts a vertical polarized lenticule, configured to filter light along a vertical polarization axis, according to one embodiment of the present disclosure.

FIG. 17C illustrates a horizontal polarized lenticule, configured to filter light along a horizontal polarization axis, according to one embodiment of the present disclosure.

FIG. 17D presents a key marker example produced using the configuration of FIG. 17A, according to one embodiment of the present disclosure.

FIG. 18A illustrates a lenticular array configuration using a UV light-capable sensor to enhance surface-level feature detection, according to one embodiment of the present disclosure.

FIG. 18B shows a key marker generated under UV illumination, revealing fluorescence-based contrast, according to one embodiment of the present disclosure.

FIG. 18C presents a UV-derived marker emphasizing surface reflectivity and encoded data, according to one embodiment of the present disclosure.

FIG. 18D illustrates a lenticular array configuration using an infrared sensor under even lighting to capture subsurface features, according to one embodiment of the present disclosure.

FIG. 18E shows a key marker produced under infrared illumination, highlighting melanin fluorescence, according to one embodiment of the present disclosure.

FIG. 18F presents an infrared-derived marker with enhanced spatial resolution of anatomical features, according to one embodiment of the present disclosure.

FIG. 19 shows an example configuration and scenario wherein three snapshots of a particular marker are taken as a subject moves across the field of view of a lenticular array, according to one embodiment of the present disclosure.

FIG. 20A illustrates a lenticular array configuration utilizing desaturation and/or high contrast image detection/processing of the marker with detail capture up to the pixel level, according to one embodiment of the present disclosure.

FIG. 20B-D illustrate key marker examples produced using desaturation and/or high contrast image detection/processing of the marker, according to one embodiment of the present disclosure.

FIG. 21A illustrates a lenticular array configuration utilizing high contrast image detection/processing, according to one embodiment of the present disclosure.

FIG. 21B-D illustrate examples of key markers codification processes that may be created using high contrast image detection/processing, according to one embodiment of the present disclosure.

FIG. 22A illustrates a lenticular array configuration utilizing a customizable key marker, according to one embodiment of the present disclosure.

FIG. 22B illustrates a digitally layered composite of key markers detected on a target using lenticular array, showing overlapping marker layouts for authentication and identification, according to one embodiment of the present disclosure.

FIG. 23 illustrates a directional grid used by the pixel codification module to track movement of a customizable key marker, according to one embodiment of the present disclosure.

FIG. 24A illustrates a data organization table showing binary representation of marker detection, according to one embodiment of the present disclosure.

FIG. 24B illustrates a data organization table displaying an alternative binary pattern for detected marker information, according to one embodiment of the present disclosure.

FIG. 24C illustrates a data organization table with a complex binary pattern for marker codification, according to one embodiment of the present disclosure.

FIG. 24D illustrates a detailed data tracking table demonstrating marker tracking using a vector approach, according to one embodiment of the present disclosure.

FIG. 25A is a side view of a lenticular array system showing optical paths from an object through the array to the image receptor, according to one embodiment of the present disclosure.

FIG. 25B is a detailed enlarged view, illustrating the structural arrangement along defined optical paths of a dual mirror lenticule within the lenticular array system, according to one embodiment of the present disclosure.

FIG. 25C is a side view of the lenticular array system showing the alignment of components for capturing images, according to one embodiment of the present disclosure.

FIG. 25D is a front view taken generally along line 25D-25D in FIG. 25C, illustrating the arrangement and configuration of multiple mirror lenticules within the lenticular array, according to one embodiment of the present disclosure.

FIG. 25E is a perspective view of the complete lenticular array system showing the three-dimensional configuration of components and light paths, according to one embodiment of the present disclosure.

FIG. 26A shows a top view of a circular lenticular array system with multiple aiming objectives arranged around a central axis, demonstrating angular orientation and light redirection toward an image sensor, according to one embodiment of the present disclosure.

FIG. 26B provides a close-up view of a mirror lenticule, illustrating its internal reflective structure and alignment with rotational axes for accurate light redirection, according to one embodiment of the present disclosure.

FIG. 26C presents a side view of the lenticular array with the image sensor positioned at a focal distance to capture light from each lenticule, including those using mirror-based redirection, according to one embodiment of the present disclosure.

FIG. 26D shows a front view of the array layout, highlighting the circular arrangement and angular positioning of aiming objectives relative to the central axis and image sensor, according to one embodiment of the present disclosure.

FIG. 26E illustrates a perspective side view of the complete circular lenticular array system, according to one embodiment of the present disclosure.

FIG. 27A illustrates a schematic diagram of a geometric example of a digitally layered key marker configured in a star-like arrangement, according to one embodiment of the present disclosure.

FIG. 27B presents an alternative geometric pattern design of a digitally layered key marker, according to one embodiment of the present disclosure.

FIG. 27C depicts an intricate layout representing a higher-order spatial organization of a digitally layered key marker, according to one embodiment of the present disclosure.

FIGS. 28 A-E comprise a flow chart showing the methodology to setup a lenticular array and produce a lenticular key, according to one embodiment of the present disclosure.

### DETAILED DESCRIPTION OF THE EMBODIMENTS

Reference is now made in detail to the description of the embodiments as illustrated in the drawings. While several embodiments are described in the connection with these drawings, there is no intent to limit the disclosure to the embodiment or embodiments disclosed herein. On the contrary, the intent is to cover all alternatives, modifications, and equivalents.

It should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this disclosure as required by 35 U.S.C. § 112.

Presented is a system and method are disclosed for generating a substantially non-replicable lenticular key, by configuring a lenticular array to capture multi-angle optical data from a target. The lenticular array is positioned at a defined distance in front of the target, an aiming objective is chosen, and the image receptor and array support are aligned relative to the aiming objective. At least two lenticules from the lenticular array are used along with a digital layout to ensure lenticule alignment between the image receptor and the target. The lenticular array may be spatially rotated using a mobility mechanism to optimize angular orientation. A light source is provided to illuminate the target, and the system may incorporate various sensors and/or filters such as RGB-alpha, ultraviolet, infrared, or others. This configuration enables precise optical path control and supports the generation of codified lenticular keys for imaging, authentication, or data processing applications.

A method for setting up a lenticular array is disclosed, the method comprising setting up a lenticular array at a specific distance in front of a target, selecting an aiming objective on the target to be detected by an image receptor, positioning the image receptor and a lenticular array support in relation to the selected aiming objective, selecting at least two lenticules from the lenticular array to use in relation to the position of the aiming objective, determining a layout for the lenticular array, wherein the selected layout for the lenticular array includes at least one array with lenticule alignment between the image receptor and the aiming objective, rotating the lenticular array along X-Y-Z axes within the layout using a mobility mechanism; providing a light source for the aiming objective; and setting up at least one of a red-green-blue alpha sensor, an ultraviolet-capable sensor, an infrared-capable sensor, and other sensors.

The layout for the lenticular array may be selected from the group consisting of linear, rectangular, vertical, horizontal, diagonal, circular, triangular, asymmetric, symmetric, fractal, organic, irregular, regular, mixed, and other layouts. The mobility mechanism may provide for lenticule adjustment operations including at least one of lenticular tilt, lenticular shift, lenticular slide, lenticular rotation, lenticular linear displacement, lenticular circular displacement, and lenticular pivotal displacement. The light source may be selected from an ultraviolet (UV) lighting setup, a white lighting setup, a colored lighting setup, a backlighting setup, a silhouetted lighting setup, a polarized lighting setup, an even surrounding ring lighting setup, and other lighting setups.

Further disclosed is a method for producing a lenticular key, comprising capturing a plurality of image sequences using a lenticular array positioned between an image sensor and a target, wherein the capturing uses a red-green-blue alpha sensor, an ultraviolet-capable sensor, an infrared-capable sensor, or other light sensors, selecting at least one key marker on the target, analyzing the at least one key marker across the plurality of image sequences to determine lenticular key data including movement vectors and ON/OFF pixel frame sequences, organizing the lenticular key data in a database, and generating a lenticular key based on the lenticular key data.

At least one silhouetted backlit key marker may be detected on each captured image, and the key markers may be digitally layered for analyzing any changes in the key markers across the captured images over time. The silhouetted backlit key markers may be analyzed to measure changes in distances, angles and/or vectors across the plurality of image sequences. The digital layering of key markers may include using a regular overlapping layout of key markers, using an irregular overlapping layout of key markers, and/or using mixed regular and irregular overlapping layouts of key markers. In some embodiments, the at least one key marker is a quantifiable object from the group consisting of the spectrum of light, black vs. white, pixel count, line count, vector direction, and/or area within the plurality of image sequences.

In a preferred embodiment, a lenticular array system is disclosed, the system comprising a target having at least one key marker, an image receptor placed in front of the target, the image receptor configured to capture a plurality of images of the at least one key marker, a lenticular array positioned between the object/subject and the image receptor, the lenticular array having a plurality of lenticules organized in a specific order for providing a substantially non-replicable representation of the key marker.

The lenticular array may be comprised of a combination of at least one of the following groups: a diverging lenticule, a series of diverging, flat and converging lenticules, a telephoto capable lenticule, a macro capable lenticule, a polarized lenticule, a parallel and perpendicular lenticule across the polarized lenticule, a colored lenticule and an irregular lenticule.

Individual lenticules of the lenticular array may be organized following a pre-determined layout where all lenticules are aligned form a unified lens structure. A support grid may be configured to provide structural support around each lenticule and to ensure the proper alignment of the lenticules. At least one mobility mechanism provides for the mechanical adjustment of at least one lenticule. An aiming objective may be characterized by the alignment of the lenticular array for viewing and detecting the at least one key marker by the image receptor.

In some embodiments, the lenticular array may be a single lenticule, wherein a lenticular image is generated using a composite of two or more views taken through a single lens. Such views may be obtained by adjusting the orientation of the single lenticule relative to the target. The lenticule may be manually re-positioned by a user to obtain such views. The resulting lenticular image may then be processed (alone or in sequence with additional lenticular images) to generate a lenticular key as further described herein.

A field grid image processing assembly may be operationally coupled to the lenticular array. The field grid image processing assembly may be configured to process the captured images, wherein the field grid image processing assembly further comprises a pixel codification module and a storage module, wherein the pixel codification module tracks the at least one key marker across captured images using a vector approach to recognize pixel movement, and wherein the field grid image processing assembly is configured to generate a lenticular key based on the recognized pixel movement.

In some embodiments, the image processing assembly generates a silhouette from the target within each captured image, wherein the at least one key marker is determined based on an analysis of each silhouette, and wherein the lenticular key is created based on an analysis of changes in the silhouettes across captured images.

The at least one key marker may be selected from the group including skin color, veins, bumps, moles, tattoos, skin surface, imperfections, holographic features, subsurface features, birthmarks, printed images, clothing and scars.

The image receptor may be a camera and/or a sensor, and the lenticular array may have one or more converging lenticules, diverging lenticules, flat lenticules, mirrored lenticules, polarized lenticules, colored lenticules, irregular lenticules, distorted lenticules, or any combination of the foregoing.

The lenticular array may comprise a lighting set up, a red-green-blue-alpha sensor, an ultraviolet-capable sensor, an infrared-capable sensor, and other sensors. The lenticular array may further include color filters to expand the capacity to codify information detectible from the captured images.

The unified lens structure may be a lenticular sheet connecting all the lenticules in a single device. The pixel codification module may be configured to codify pixel movement over time with a pre-determined vector across a plurality of consecutive frames of captured images. The process of decomposing the original marker into limited visual details utilizes several optical techniques, each tailored to specific detection scenarios. These techniques enable the lenticular key to isolate and enhance marker features for codification and recognition. The at least one key marker may be refracted/reflected by the lenticular array before the marker is captured by the image receptor.

In another embodiment, a lenticular codification system is disclosed, comprising a target as a subject and/or an object, a plurality of lenticules arranged into a lenticular array, and a lenticular key as a device for digital codification of the target. The system enables capturing of a plurality of images of the target through the lenticular array, and the captured images are digitally analyzed to produce the lenticular key.

In a further embodiment, a system for detecting and processing customizable key markers is disclosed, comprising a lenticular array positioned between a target and an image sensor, a lighting source configured to illuminate the target with high-contrast lighting, wherein the target includes a customizable key marker comprising pixelated regions, line segments, and vector tracking points, wherein the image sensor captures the key marker through the lenticular array; and wherein the key marker is quantifiable based on at least one of black versus white pixel count, line count, vector direction, and area-specific features. Digitally layered frame sequences and overlapping layouts of the captured key marker may be used to generate a composite representation.

The key marker may be recognized by computer software and used to align the target in post-processing. The lenticular array is configured to enable detection of silhouetted backlit key markers, and to support determining spatial measurements including horizontal distance, angular orientation, and vector tracking. A lenticular key may be generated based upon one or more detected changes in the key marker across a plurality of captured frame sequences.

Referring now to the figures generally, a lenticular array 102 may comprise a physical object made of glass, plastic, or any other translucent material capable of modifying light rays with high levels of accuracy and clarity. FIG. 1 is an illustration showing the primary components for lenticular key codification, namely a target 104, a lenticular array 102, and a key marker 106, according to one embodiment of the present disclosure. The target 104 refers to a person or non-human body object/subject positioned in front of the lenticular array 102, whose spatial profile is optically sampled by the array. The lenticular array consists of structured lenses that selectively capture and encode visual attributes of the subject across multiple angles.

The encoded light is projected in the form of a key marker 106, which is a composite image incorporating distinctive biometric or symbolic details, such as facial features or identifier elements (e.g., an eye or rose, as depicted) based on the captured input. This transformation enables secure, non-replicable encoding of the subject, with the resulting pattern serving as a high-fidelity signature recognized by an optical receptor such as a camera or image sensor 108.

The present disclosure provides a combination of optical lenses that are organized in a specific order, becoming a unique and non-replicable representation of the subject/marker in front of it. The combination of different lenticular components adjacent to each other provides a large amount of information that is passed to the receptor (camera/sensor).

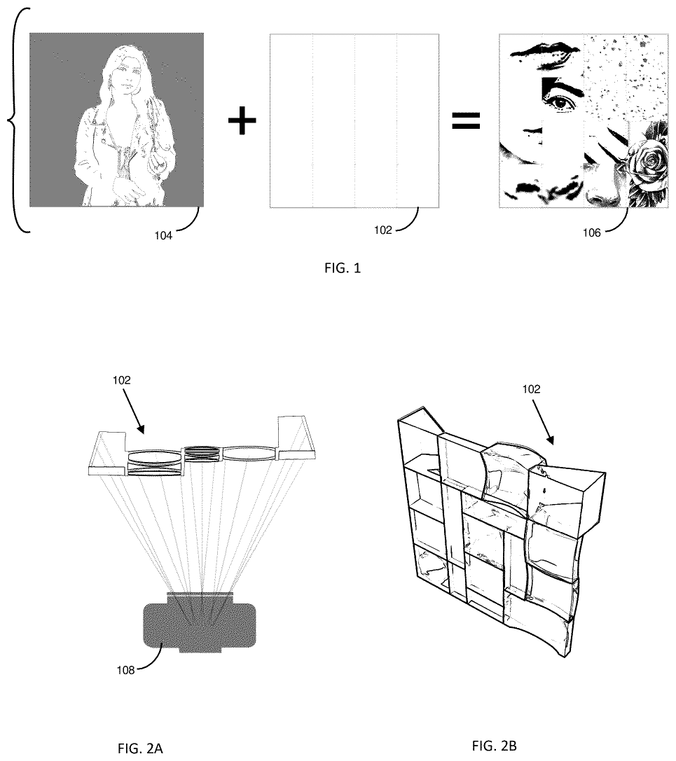

The organization of lenticular components follows a custom layout where all pieces are aligned, forming a sheet of lenses. FIG. 2A illustrates a top view of a lenticular array 102 positioned above an image sensor 108, configured in accordance with one embodiment of the present disclosure. As shown, incoming light traverses the array and is directed toward image sensor 108, resulting in controlled optical modification. This configuration enhances image capture capabilities by spatially encoding visual input across multiple angles, thereby improving sensor resolution and recognition fidelity.

FIG. 2B shows a perspective view representation of a lenticular array 102, according to one embodiment of the present disclosure. The array comprises a series of lenticular lenses arranged in a grid pattern, each designed to redirect incident light rays for precise optical modification. The spatial orientation and curvature geometry of these lenses facilitate controlled convergence of light onto an associated sensor surface, such as image sensor 108. This configuration supports multi-angle sampling and spatial encoding of visual data, enhancing recognition fidelity and enabling complex image formation mechanisms based on parallax behavior.

The number of components is variable and can go from 2 or 4 lenticules in a single lenticular array to thousands of lenticular components connected together, or arranged in layers of lenticules, all with one purpose: modify the image of the subject/marker in front of it, and pass that modified marker to the receptor (image sensor 108) as a key marker 106. A lenticular key marker is the resulting product of an array of lenticules (component lenses) in layers that provides optic characteristics and other useful photographic information. A lenticular key can be further described as comprising a digital marker comprising an image (or set of images) as seen through the array of lenticules using a sensor, plus an image processing component (e.g. comparison of multiple images over a period of time (t1, t2)). Many combinations of photographic and optic techniques may be combined, arranged and used together to comprise a lenticular key.

Lenticular lens arrangements may comprise arrays, layouts, frames, sheets, and/or grid structures of individual lenses (or lenticules). Within any given arrangement of lenses, individual lenses may be movable, allowing significant flexibility and change in its structure and organization, altering the characteristics of the images capturable through the lens array.

Visual markers, for example on a subject's body, may form different optic, photographic, or visual means to obtain a codified result, permitting many new and unique programming opportunities, particularly in the fields of image and video processing. Lenticular key markers may be made of the combination of one or multiple markers, segments of markers, details, or broad segments pertaining to one or more targets to be viewed. The detection of markers through a lenticular lens array may be compared across a set timeframe and at variable viewing angles and distances. A lenticular key may be the result of a marker seen through a lenticular array using a sensor or a camera in which detection is performed over a set period of time (for example, across multiple snapshots taken at times t1, t2, and t3).

Markers on a target 104 include any or all biometric data, not necessarily in the traditional sense, e.g. shape, color, texture, and they are not limited to birthmarks, scars, tattoos, moles, eyebrow shapes, lip shapes, nose, nostrils, eye shapes, pupils, ear shapes, mustaches, beards, subsurface skin marks, subsurface veins, makeup, hair color, teeth, fingernails, finger shapes, symmetry, asymmetry. Additionally, markers do not have to be located only on the human body, they can be on any other live or mechanical subject/object.

The combination of these and any other marker type and their relationship in scale, ratio, color, contrast, topology, etc. become the source to create the new key marker as seen through the lenticular lens, sensed through the lens array by a sensor/camera, as a snapshot or as multiple snapshots arrayed or over a set amount of time. In one embodiment, the lenticular key provides a layer of codification to an existing marker on a subject/object. For example, by combining the subject's unique features and the unique configuration of the optical components of the lenticular key, a physical code that needs both parts to function may be created. One can imagine this new object as comparable to what a fingerprint and a physical key would do if they worked together to open a door.

The organization of each lenticule/lens component next to others follows a pre-planned arrangement which may include rectangular arrangement, vertical arrangement, horizontal arrangement, diagonal arrangement, circular arrangement, organic arrangement, triangular arrangement, or other geometric non-symmetric and symmetric arrangement, and fractal-based organization of lenses. Still. Each lenticule can have its own shape to function properly, and/or they can be cut to match the layout. By planning the size and shape of each lenticule/lens in a key map, the lenticular key becomes a unique object. Each lens component with a specific focal length, aperture, lens speed, and size, participate in the organization of the lenticular key. The layout of the lenses may provide limitations to the optical functionality of each lens/component, becoming a factor in the design of the key results.

In a preferred embodiment, the layout for the lenticular array can be selected from various options including linear, rectangular, vertical, horizontal, diagonal, circular, triangular, asymmetric, symmetric, fractal, organic, irregular, regular, mixed, and other layouts. Each layout offers unique advantages for specific visual capture requirements. The components may also include multiple layers of lenticules/lenses to provide longer focal lengths and wider or narrower views of different shapes and sizes. The focal length of such lenses represents a variation in the depth and structure of the resulting image. The benefit of variable focal lengths provides more options of proximity to the desired subject/marker.

It should be noted that lenticular key layouts are not limited to the embodiments illustrated herein. The physical positioning and spatial alignment of lenticules within the lenticular array 102 may vary to accommodate different image encoding requirements. Each lenticule contributes to a precise pattern arrangement that enables high-resolution optical modulation. Variations in curvature, spacing, and grid topology may be implemented to adjust depth effects, enhance sensor sensitivity, or encode subject-specific biometric information.

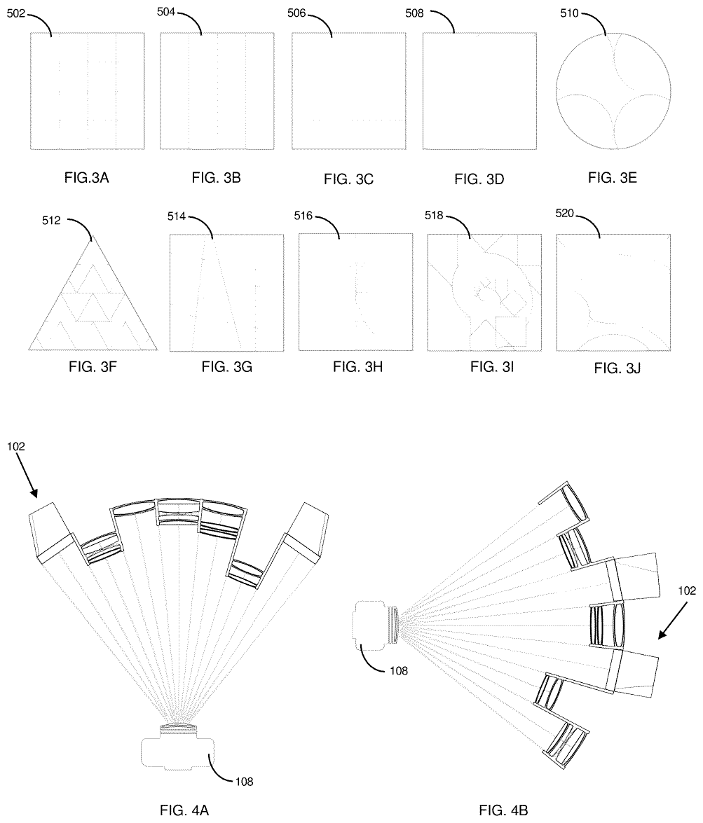

FIGS. 3A through 3J illustrate representative lenticular key layouts incorporated within lenticular array 102, each demonstrating a unique configuration to modulate focal depth, parallax behavior, and image presentation. The type of lenticules to use is selected in relation to the position of the aiming objectives. The selection of lenticules is crucial as different types of lenticules can create different visual effects and capture different aspects of the subject or object.

FIG. 3A shows a rectangular layout 502, comprising evenly distributed rectangular lenticules that promote consistent depth and balanced focal convergence. FIG. 3B depicts a vertical layout 504 wherein the lenticules are longitudinally aligned along the vertical axis, enhancing vertical parallax and facilitating image transitions responsive to top-down viewer motion. FIG. 3C presents a horizontal layout 506, characterized by lenticules oriented laterally across the lens surface to extend focal length horizontally and support panoramic imaging. FIG. 3D illustrates a diagonal layout 508 formed by angled lenticules that introduce oblique parallax variation, producing dynamic optical shifts as the receptor's angle changes along diagonal vectors. FIG. 3E features a circular layout 510 with radially positioned lenticules curving around a central point to enable omnidirectional focal responsiveness and rotational image symmetry. FIG. 3F portrays a triangular layout 512 where the lenticules are arranged in geometric triangle formations, offering acute focal convergence and emphasized spatial directionality. FIG. 3G exemplifies an asymmetry layout 514 with irregular lenticule distribution and orientation, producing varied and non-linear focal depth profiles conducive to custom or expressive optical effects. FIG. 3H demonstrates a symmetry layout 516 comprising bilaterally symmetric lenticule arrangements, designed to provide uniform viewing zones and predictable image transitions. FIG. 3I displays a fractal layout 518 that integrates recursive, self-similar lenticule patterns to support multi-layered depth rendering and scalable parallax transitions with geometric precision. Finally, FIG. 3J introduces an organic layout 520, defined by flowing lenticule paths that emulate natural contours such as waves or biological forms, ideal for generating smoothly evolving image sequences and continuous focal adaptation. Each of these configurations may be implemented singularly or in combination, including as multilayered lenticular arrays, to achieve variable focal lengths, customized depth perspectives, and tailored viewing angles. The disclosure is not limited to these embodiments and encompasses other geometries suited for lenticular imaging systems.

As shown in FIGS. 4A and 4B, the lenticular array 102 can be arranged in different configurations above the image sensor 108. FIG. 4A illustrates a top view of a schematic diagram of a fan-shaped arrangement of a lenticular array 102 and image sensor 108 according to one embodiment of the present disclosure. FIG. 4A illustrates a fan-shaped arrangement demonstrating how multiple lenticules capture different perspectives of the target subject. FIG. 4B shows an alternative angular configuration with lenticules arranged vertically to capture specific aiming objectives from the target. The combination of specific lenticular array layouts, mobility mechanisms, lighting setups, and specialized sensors enables comprehensive capture of both visible and non-visible markers from the subject/object, resulting in a detailed codified representation that contains unique identifying features.

FIG. 4B illustrates a schematic diagram of an alternative angular configuration of the lenticular array 102 in relation to an image sensor 108 according to one embodiment of the present disclosure. The way all lenticules/lenses are set up and connected may vary based on the type of layout and optic attributes of each lens. The arrangement of the layout can be done using direct contact between separate lens parts, using a supporting grid that brings lenses together, or in a custom 3D print in which all lenses are one piece.

A supporting component or grid can be made of a non-translucent solid material that works as a structural frame around each lenticule/lens to ensure the proper alignment of all lenticules/lenses. The support component may connect the lenticular array to the sensor or structural system for the whole apparatus in preparation for viewing key markers 106. The frame offers opportunities to generate combinations for fixed “prime” lenses or movable lenses supporting variable focal lengths, zooms, tilt and shift attributes, and others. It may also have features to facilitate multiple layered lenticular keys to increase the degree of sophistication. A lenticular array may be utilized to work in configuration with one or more other lenticular arrays, in addition to more than one image sensor 108 depending on the requirements of the application.

Lenticular arrays can have single or multiple pieces of glass or any other refractive, reflective material laid on each other to provide the desired optical result. Equally, combining two or more superimposed lenticular arrays increases the opportunity to enhance optics and improve the capacity to codify the markers layers and repetition of markers in time seen through the lenticular lens.

Referring now to FIGS. 5A through 5D, a lenticular array 102 is disclosed, comprising a plurality of mobility mechanisms configured to permit dynamic repositioning of lenses and associated structural components. These mobility features enable spatial variations in lenticule placement and marker detection patterns. The array includes structures exhibiting flexible, rotatable, and translatable properties that promote operational adaptability under a range of positional and environmental constraints.

FIG. 5A illustrates a flexible lenticular array structure 160, designed to conform to curved or irregular mounting surfaces. This structural flexibility facilitates accommodation of non-planar installations and supports refined modulation of incident light along varied contour geometries. FIG. 5B is a schematic diagram that depicts a lenticular tilt mechanism 156 comprising individual lenticules each capable of rotational mobility. The lenticules may rotate about their respective axes to alter capture angles, thereby allowing focal correction and optimized directional alignment with image sensor 108. FIG. 5C is a schematic diagram that presents a lenticular shift mechanism 152 configured to effectuate linear displacement of lenticules along a horizontal axis. This shifting function permits modulation of the capture perspective and compensates for spatial disparities between target 104 and image sensor 108.

FIG. 5D is a schematic diagram that illustrates a lenticular slide mechanism 154, according to one embodiment, enabling coordinated lateral displacement of individual lenticules or grouped lens assemblies within lenticular array 102. The sliding functionality may be actuated manually or via motorized control to support real-time repositioning of optical axes and correction of off-center ray propagation. Multi-axis slide mobility enhances the adaptability and responsiveness of the array in dynamic imaging environments, particularly where the orientation of target 104 or image sensor 108 is variable.

During system operation, lenticular array 102 receives light from target 104 and channels it through a distributed arrangement of lenticules, each configured to capture a slightly offset visual perspective. These multiple perspectives converge to form a layered optical signal encoding spatial and visual features of the subject. The composite output imparts dimensionality to the encoded data, which may be projected onto key marker 106 and captured by image sensor 108.

The inclusion of tilt, shift, and slide mobility within the lenticular array enables generation of distinctive visual markers suited to subject identification, authentication protocols, and analytical assessment. To address misalignments between lenticular array 102 and image sensor 108, particularly those leading to off-center ray propagation, the system may integrate supplemental optics including tilt-shift lenses, Off-Axis Meta-Lenses, or depth-enhancing technologies such as Lytro-type focal stacking systems.

Further, the array may incorporate mechanisms permitting independent movement of structural subgroups, allowing deviation from both the nominal array plane and the image sensor plane. Such reconfigurable geometry facilitates rotational and translational repositioning, thereby converting the array into a spatially versatile optical system responsive to application-specific marker detection requirements.

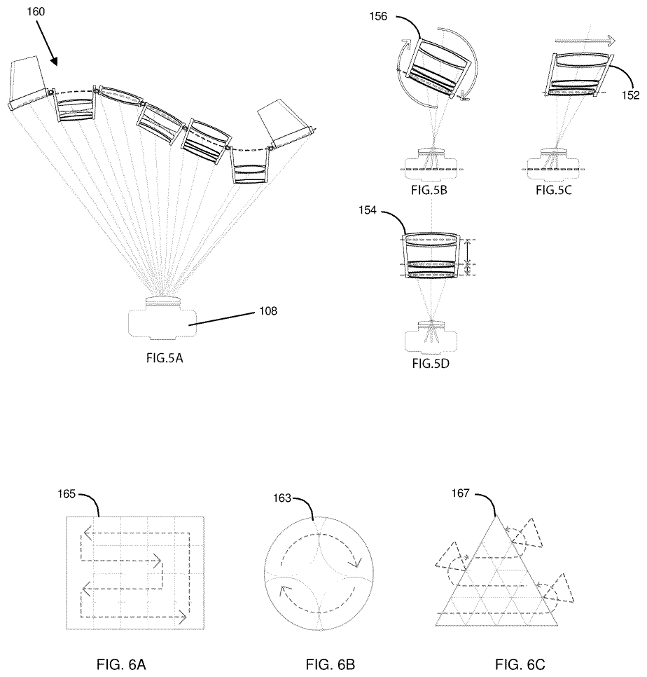

Referring now to FIGS. 6A through 6C, multiple layout configurations of lenticular array 102 are disclosed, each enabling directional arrangement and mobility of individual lenticules for dynamic imaging applications. The lenticular array may be selectively configured in geometric formats that optimize light capture and marker generation across varying spatial orientations.

As depicted in FIG. 6A, lenticular array 102 assumes a rectangular layout 164 comprising a linear arrangement of lenticules. This configuration facilitates horizontal and vertical displacement through lenticular shifting, thereby supporting directional modulation across the X-Y axis. FIG. 6B illustrates a circular layout 163, wherein lenticules are arranged in a radial pattern enabling angular displacement and curved lens behavior. Directional indicators may be provided to represent radial alignment and movement orientation. FIG. 6C presents an alternative embodiment in which lenticular array 102 is configured in a triangular layout 168, allowing lenticules to be internally organized within geometric constraints. Such pattern-based configurations support structured and customizable displacement for multi-angle image acquisition.

The disclosed layout configurations permit movement of lenticular components along the X, Y, and Z axes. Traditional displacement applications may be employed, such as focal modulation through variation in inter-lenticule spacing. This technique is consistent with existing practices in photographic lens systems, wherein optical depth is altered by adjusting focal distances.

In another embodiment, mobility of lenticules is enabled via mechanical actuation elements including sliders, rotators, pivots, hinges, shifters, poles, and other structural connectors. These components provide degrees of freedom in each spatial plane and may allow dynamic adjustment of lens orientation and interactivity with the supporting array grid. Movement is not limited to horizontal, vertical, or diagonal paths, but may include rotational pivoting and collective repositioning of lenticular rows or columns.

Lenticule mobility may be further enhanced by motorized systems configured to interact with spatial voids and inter-component channels between customized lenticular pieces. These motor assemblies facilitate controlled displacement, structural support, and dynamic repositioning of array components in response to application-specific imaging requirements.

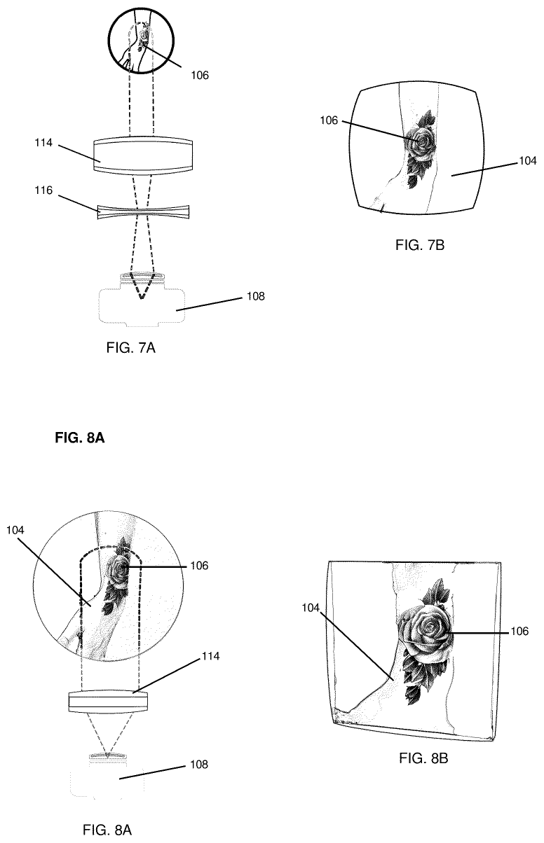

FIGS. 7 to 19 illustrate a lenticular imaging system configured to produce a diverse range of optical effects, including standard, telephoto, wide-angle, and ultra-wide perspectives. The system employs both converging and diverging lenticules to achieve variable focal behaviors.

FIG. 7A illustrates a lenticular imaging arrangement comprising a converging lenticule 114 and a diverging lenticule 116, each positioned at a predetermined distance from target 104. The object includes marker 106, which in one embodiment is a floral tattoo design located on the target 104. The distance between the lenticular elements and the object is configured based on the focal properties of the lenticules and the desired image resolution characteristics. The combination of converging and diverging lenticules facilitates directional modulation of incident light, as illustrated by dashed lines terminating at image sensor 108. Diverging lenticule 116 contributes to angular encoding, enhancing capture fidelity of marker-specific geometric and spatial information.

FIG. 7B depicts a schematic representation of a codified key marker derived from the imaging configuration of FIG. 7A. Marker 106, comprising a floral element, is captured through the lenticular optical system at a defined temporal interval. The resulting snapshot incorporates positional geometry, view-dependent distortion, and temporal uniqueness, forming a high-resolution encoded visual artifact.

The imaging system enables acquisition of multiple distinct key markers by directing light emitted or reflected from target 104 through lenticular array 102 toward image sensor 108. The system produces high-density visual signatures tailored for object identification, subject authentication, and marker analysis.

FIG. 8A illustrates an alternative lenticular array configuration utilizing a converging lenticule 114 and flat lenticules 118. This design allows selective modulation of light rays for controlled focus and depth uniformity.

FIG. 8B presents an example key marker 106 associated with target 104, generated using the lenticular configuration of FIG. 8A. The encoded image reflects the optical influence of both converging and flat lenticules, producing a spatially aligned marker suitable for verification or recognition tasks.

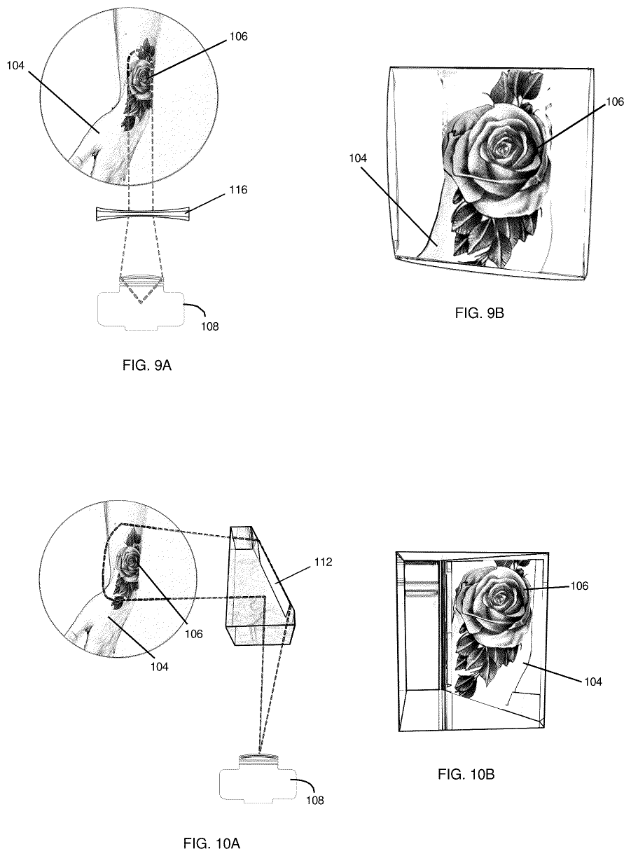

FIG. 9A illustrates an alternative lenticular array configuration utilizing a diverging lenticule 116. As shown in FIG. 9A, the image sensor 108 is positioned below the diverging lenticule 116, with the optical path (indicated by dashed lines) aligned to capture the selected aiming key marker 106 on the target 104. This design allows selective modulation of light rays for controlled focus and depth uniformity.

FIG. 9B presents an example key marker 106 associated with target 104, generated using the lenticular configuration of FIG. 9A. FIG. 9B provides a rectangular view of the target 104 and target region marker. 106, displaying a floral pattern. The encoded image reflects the optical influence of the diverging lenticules, producing a spatially aligned marker suitable for verification or recognition tasks.

FIG. 10A illustrates a lenticular array configuration incorporating a mirror lenticule 112, which is designed to facilitate reflection-based optical modulation. Unlike transmissive lenticular elements that rely on light passing through the lenticular body, the mirror lenticule receives incident light from a subject or object positioned in front of or adjacent to the array and reflects that light along a defined optical path toward an image receptor.

This non-penetrative configuration introduces a distinct encoding strategy within the lenticular framework, enabling controlled directional modulation through angular reflection. The reflective pathway allows for the capture of angular data without direct transmission through the lenticular substrate, thereby expanding the system's ability to codify optical information from non-standard orientations.

The mirror lenticule 112 is particularly effective in accessing markers located on surfaces that are not easily visible using traditional converging or diverging lenses. Its reflective attributes enable the lenticular key to detect markers at oblique angles, including those that follow the curvature of anatomical surfaces such as the human body. This capability enhances the system's versatility in capturing codified data from complex geometries and non-planar regions.

FIG. 10B presents a key marker 106 produced via the mirror lenticule configuration shown in FIG. 10A. The marker image encapsulates reflected visual information derived from the surface characteristics of the target 104. In one embodiment, the marker may represent biometric or symbolic data, such as tattoos, facial contours, or emblematic features. By utilizing mirror-based light redirection, the system can generate unique optical patterns associated with the subject, suitable for identity verification, spatial mapping, or object tracking under constrained lighting or directional conditions.

This reflective geometry facilitates the detection and codification of optical data from curved or obliquely oriented anatomical surfaces. The system is particularly effective in capturing biometric or symbolic features such as tattoos, facial contours, or emblematic identifiers that may reside on non-planar regions of the body. By leveraging mirror-based light redirection, the lenticular array produces unique optical patterns associated with the subject, even under constrained lighting or directional conditions.

The resulting marker image serves as a codified representation of the subject, suitable for applications including identity verification, spatial mapping, and object tracking. The reflective modality supports multi-angle imaging and enhances the system's ability to access markers that are otherwise obscured or inaccessible using conventional converging or diverging lenticules. This physical manipulation of light, via controlled reflection, is complemented by a digital processing system that receives the lenticular key marker and performs a series of operations including capture, alignment, data analysis, organization, labeling, storage, querying, retrieval, matching, recognition, identification, and authentication. The integration of mirror lenticules into the lenticular array thus enables the production of authentic and irreplicable representations of the target, forming a foundational component of the broader codification architecture.

Furthermore, this reflective modality may be combined with other lenticular configurations to form hybrid systems capable of capturing, organizing, and authenticating optical data across a wide range of imaging conditions. Such hybridization supports scalable deployment in biometric security, augmented reality, and advanced object recognition platforms.

FIG. 11A illustrates a lenticular array configuration employing polarized lenticule 130A and non-polarized lenticule 130B, each serving as a light-modulating interface for light source 140 and associated optical refraction devices. The polarized lenticule 130A selectively filters incident light along one or more polarization axes, thereby restricting and shaping the optical throughput in accordance with directional polarization rules. In contrast, non-polarized lenticule 130B permits light transmission without angular polarization bias, enabling a broader spectrum of light path interactions within the array. In certain embodiments, the dual-lenticule configuration facilitates refined control over image encoding via differential light modulation.

FIG. 11B illustrates a key marker generated via the polarized lenticule configuration of FIG. 11A. The marker incorporates encoded optical traits based on polarization alignment, which may selectively enhance or suppress visual details under controlled lighting conditions. Such markers may be especially suited for identity tokens, security tags, or biometric indicators requiring authentication in polarized lighting environments.

FIG. 11C presents a key marker produced using the non-polarized lenticule configuration shown in FIG. 11A. The resulting marker displays a full-spectrum image encoding, derived from unfiltered light behavior across the lenticular surface. In one embodiment, the marker may retain richer visual textures and ambient details, suited for expressive imaging applications or non-authenticated object tagging where fidelity in uncontrolled light environments is preferred.

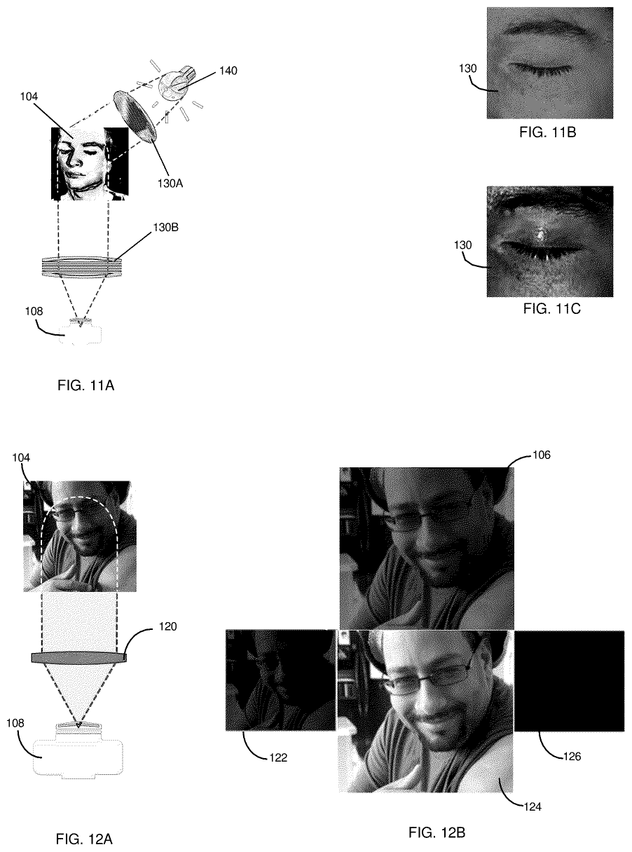

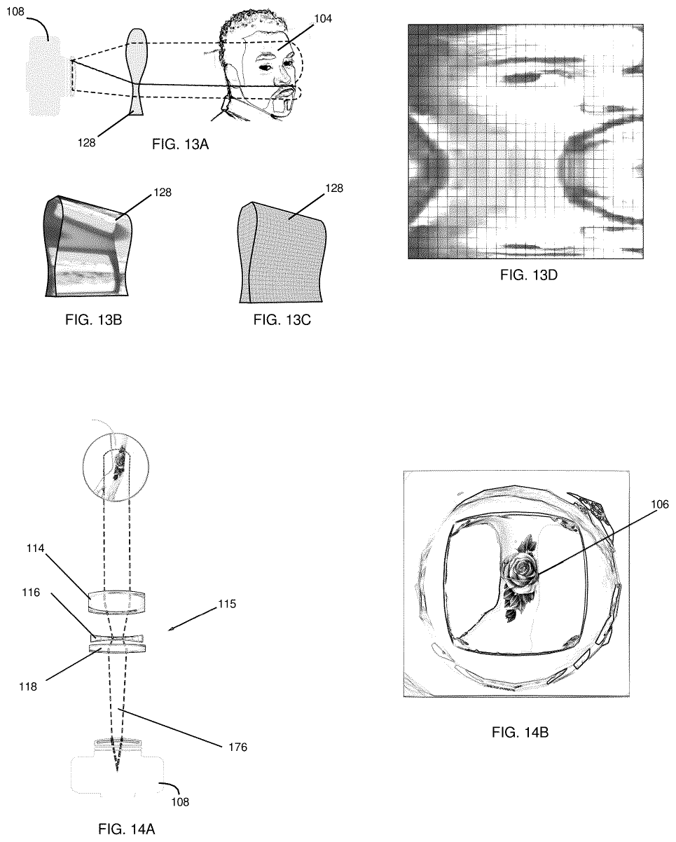

FIG. 12A illustrates a lenticular array configuration utilizing colored or color-filtered lenticules 120. The lenticules may include red filter 122, green filter 124, or blue filter 126 (RGB configuration) for wavelength-selective light modulation. The array receives incident light from a target 104, such as a human subject, and separates it spectrally to capture chromatic traits producing key markers red filter 122, green filter 124, or blue filter 126 respectively. These traits include information that can be used to determine color pigmentation, melanin concentration, hemoglobin diffuse reflectance, carotenoid presence, subsurface light transmission, and related health indicators. The RGB separation enables detailed imaging of skin characteristics across multiple biological parameters. The use of color photographic filters has additional variables to facilitate the codification of the marker:

A first use of color photographic filters is color correction. It is known in the arts of black and white photography that usage of specific colored filters facilitates the capturing of light and features on human skin. An example of this application is the use of red filter to enhance the details of a portrait photo. In the application of the current disclosure, a red color lens will facilitate the sensor/camera receptor and connected software to separate RBG channels. In such case, the isolated red channel used as a grayscale image, will provide a higher degree of detail from the marker.

A second use of color photographic filters where color filters expand the features of the system is the use of a determined color filtering layer that are known by the receiving receptor system through the camera/sensor. The application of this method and system works when the subject/object is placed under a consistent lighting source, (i.e. white light at 1400 lumens) and the camera or receptor captures information at a predetermined sensitivity, speed—ISO, or aperture in the case of a camera lens.

Most light sources emit a wide range of Red, Green, and Blue wavelengths. Light wavelengths are measured in Nanometers. When using colored filtering between lenticular Key and the subject-object, the lenticule can restrict a wavelength spectrum. This can be accomplished by selectively absorbing or reflecting unwanted wavelengths.

Absorption color filters selectively transmit the wavelengths of one or two colors from the white light spectrum (i.e. red and blue) while absorbing most of the third color wavelength (i.e. green). The use of Absorption filters may be applicable but with some limitations.

The use of such filters modifies the refracted image after it passes the lenticule array. The wavelength of each color is modified. As a result the marker loses brightness, as a result images will have a different numeric in nanometers, or RBG values once in the computer. The standard wavelength in nanometers follows these standard ranges:

### The Visible Light Spectrum

| Color | Wavelength (nm) |
|---|---|
| Red | 625-740 |
| Orange | 590-625 |
| Yellow | 565-590 |
| Green | 520-565 |
| Cyan | 500-520 |
| Blue | 435-500 |
| Violet | 380-435 |

Once a marker has been modified by an absorption lens. The original color information of the marker reduces its measurable wavelength. As a result, the receiving system processing the image captured by the sensor or camera can match the key marker image with the information stored in its database. This process allows for unique colored filters used on different lenticular keys. Lenticular keys can be made of colored filters that change the wavelength detection value.

When digital images are read, they can also be processed by reading the RGB values on a pixel-by-pixel basis. Colored filters change the read at the pixel-by-pixel level.

Interference filters, also known as dichroic filters, reflect the undesired wavelengths and allow precise modified wavelengths. The interference filters destructively interfere with the image passed through the lenticule, generating a new colored, or in most cases a grayscale image.

When a subject/object is placed under a controlled light source, the markers on the body or object are seen through the lenticular key with a new reading of color. The new reading of color is the detection of the actual wavelengths of color on the skin or surface of the subject/object minus the filtered wavelengths removed by the interference or absorption filter. This generates a factor of detection that changes the ranges of color readings on the skin or surface. The use of this technique generates codification of the individual/object surface that is known only to the system connected to the local lenticular array.

The color of the filter becomes a variable that modifies the marker's information.
Yellow filter—transmits yellow and reflects blue
Green filter—transmits green and reflects magenta
Blue filter—transmits blue and reflects yellow

In traditional color analogue photography, colored filters are employed to modify the spectral quality of light to match the sensitivity of the film. When applied to digital sensors or cameras, the colored lenticule or lens alters the spectral composition of incoming light, thereby modifying the appearance and contrast of the marker.

When white light passes through a colored filter, all wavelengths are absorbed except those corresponding to the filter's color. This selective transmission enables enhanced contrast and detail capture in the filtered spectral band. In digital post-processing, separation of the image into RGB channels allows for increased clarity and definition of marker details, particularly in the channel corresponding to the filter used.

This technique is particularly effective in human skin detection, where chromophore analysis is relevant. Human skin contains chromophores such as melanin and hemoglobin, which absorb light at specific wavelengths. Melanin absorbs broadly, with strong absorption in the blue and ultraviolet ranges, contributing to brown and black tones. Hemoglobin, including both oxyhemoglobin and deoxyhemoglobin, absorbs in the green and red ranges, contributing to red and pink tones.

RGB cameras capture light in three broad spectral bands; red, green, and blue, each corresponding to different chromophore absorption characteristics. By analyzing the intensity of reflected light in each channel, algorithms may estimate the relative concentration of melanin and hemoglobin. However, challenges arise due to overlapping absorption spectra, specular reflection, uneven illumination, and the layered structure of skin, which may affect the estimation process.

Additionally, when colored filters are used in combination with black-and-white sensors, the filtered channel provides enhanced detail beyond standard grayscale or brightness/contrast adjustments. Red-filtered lenses, for example, offer increased definition of detail on darker skin tones, improving access to embedded marker features.

In both digital and analogue contexts, the use of colored lenses within the lenticular key provides a robust method for spectral decomposition and marker enhancement, particularly in applications involving human skin analysis and chromophore differentiation.

FIG. 12B illustrates an example of multiple key marker produced using a converging lenticule shown in FIG. 12A. The color information of the target minus the color reflected by the interference filter generates a key green marker 124 that is the unique result of the color of the marker in combination with the lenticular lens. The RGB separation of Red, Green and Blue provide the opportunity to encode information related to the skin characteristics visible its appearance including color pigmentation.

FIG. 12B illustrates multiple key markers generated by the RGB filtered lenticular configuration of FIG. 12A. The image consists of a composite arrangement of panels, each depicting the RGB light separation as a result of a colored filter. Red marker 122, green marker 124, and blue marker 126 denote discrete image regions containing encoded visual data, while marker 106 marks a fixed reference location. This composite demonstrates the system's capacity to generate enhanced detection of optical information from a target, resulting in a unique and information-rich lenticular key. The system captures chromatic and physiological traits of a subject based on incident light behavior through a plurality of colored lenticules. The encoded traits include melanin concentration, hemoglobin diffuse reflectance, carotenoid concentration, light transmitted through the skin, and related health conditions. The system is configured to generate image markers based on these traits using filtered light paths aligned with red, green, and blue spectral channels. These channels enable targeted separation and analysis of subsurface pigmentation and biological features, producing a composite marker indicative of skin appearance and wellness metrics.

A lenticular codification system comprises a target as a subject or object, a lenticular key serving as a codification apparatus, and a lenticule array forming the physical manifestation of the lenticular key. The system enables acquisition of a plurality of images of the target through the lenticule array, arranged in layers that provide optimal optical fidelity and photographic detail. The layered capture enhances multidimensional encoding and facilitates advanced image analysis or verification processes.

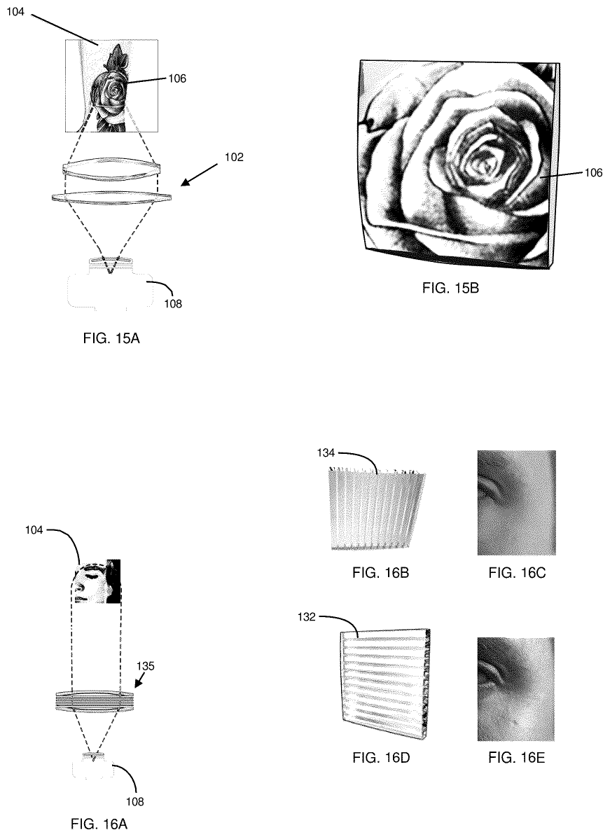

FIG. 13A illustrates a lenticular array configuration utilizing an irregular lenticule 128, according to one embodiment of the present disclosure. The lenticule exhibits non-uniform surface geometry, which may include asymmetrical curvature or irregular contours designed to enhance refraction and reflection properties for marker detection.

FIG. 13A illustrates the use of distorted mesh lenses within the lenticular key, enabling the transformation of a marker into a unique key image through controlled optical deformation. These lenses are manufactured using computer-aided design (CAD) programs and principles of optics to create non-standard, custom mesh geometries. The resulting deformation alters the visual representation of the marker when viewed through the lenticular lens, producing a distinct key image that is not readily interpretable without the corresponding decoding process.

The deformation introduced by the mesh lens can be reversed using a software application that applies principles of UV mapping and mesh component reading, techniques commonly used in modern computer-generated (CG) 3D modeling. This reversible transformation allows the system to encode and decode marker information with high specificity.

In application, the lenticular key system serves as a physical intermediary between the marker and the digital camera or sensor. This physical component introduces a layer of transformation that converts the original marker into a new, recognizable key marker. For example, in an embodiment involving access control, a subject may be recognized by stepping within the range of the lenticular key system and the associated camera or sensor. The system begins recording and tracking the subject's movement as seen through the lenticular key. Each lens in the array contributes partial information, and the software anchors detection for each specific lens. Once all lenses have provided the necessary data, the system reconstructs the complete key marker and initiates a recognition process. This approach enables secure and individualized marker encoding, particularly useful in biometric identification, access control, and digital authentication systems.

FIG. 13B depicts an enlarged view of irregular lenticule 128 comprising a three-dimensional, curved surface structure configured to redirect incoming light for codification purposes. The lenticular key in this embodiment leverages surface distortion to encode complex image features associated with the target subject.

FIG. 13C shows the arrangement of irregular lenticules 128 supported within a defined grid structure. The array is designed to maintain spatial alignment and positional stability of the lenticules while enabling controlled deviation of light through non-linear optical paths. The grid architecture aids in organizing the distorted lens elements according to a predefined pattern that facilitates multilayer image sampling.

FIG. 13D presents a key marker generated using the irregular lenticule configuration. When viewed through the array, the subject's features are dissected into a pixel-like format wherein each lenticule contributes a unique perspective, enabling high-resolution codification of visual traits. The resulting marker reflects spatial segmentation and multidimensional depth, supporting enhanced image identification and authentication.

Lenticular systems may incorporate a wide variety of lens types, including but not limited to: flat lenses; converging lenses as shown in FIGS. 7A and 8A; diverging lenses as shown in FIGS. 7A and 9A; mirror lenses as shown in FIG. 10A; perpendicularly polarized, cross-polarized, and parallel polarized lenses as shown in FIG. 11A; color-filtered lenses as shown in FIG. 12A; distorted mesh or irregular lenses as shown in FIG. 13A; blocked or opaque lenses; and any combination of the foregoing or equivalent lenticular designs. These lens types may be used singly or in combination to produce versatile optical outcomes tailored to specific codification, imaging, or tracking applications.

FIG. 14A illustrates a lenticular array combination 115 comprising a structured arrangement of converging lenticules 114 and diverging lenticules 116, configured to support long working distance imaging applications. This embodiment is optimized for targets positioned at extended focal lengths, such as long focal length 176, and is particularly suited for scenarios requiring high-resolution capture of codified markers from moderate to far distances.

The lenticular components are positioned between the target 104 and the image sensor 108 to define a multi-stage optical pathway. Incident light from the subject is selectively modulated by the combined lens profiles, enabling directional refraction and focal shaping. This modulation facilitates the generation of distinct optical signatures that can be used for marker codification, even across extended imaging ranges.

The lenticular array combination 115 incorporates a telephoto lens configuration, which enhances the system's ability to detect and resolve fine marker details at long focal distances. Telephoto characteristics allow for cropped visual access to specific regions of interest on the subject, thereby improving the resolution and fidelity of the captured data. This is particularly advantageous for applications involving authentication, recognition, or digital codification of distant targets.

The arrangement of converging and diverging lenticules within the lenticular key is harmonized with any existing lens elements on the camera or sensor. This synergy ensures that the overall optical system maintains alignment and coherence across the imaging axis, thereby preserving the integrity of the codified data. The number and type of lenticules used in the array may be varied depending on the specific working distance, resolution requirements, and desired focal shaping characteristics.

In operation, the lenticular array combination 115 supports the physical manipulation of light to produce a unique and irreplicable representation of the subject. This representation is then received by the image sensor and processed by a complementary digital system, as described in later sections, to extract, organize, and utilize the codified optical data. The system is scalable and modular, allowing for adaptation to various imaging environments and target profiles.

FIG. 14B presents an example of a key marker 106 produced using the configuration depicted in FIG. 14A. In this embodiment, the marker is derived from visual data captured across converging, flat, and diverging lenticular profiles. The encoded image reflects subject-specific features, rendered in layered optical depth and spatial separation due to the extended focal length 176 and lenticular interplay.

FIG. 15A illustrates a lenticular array configuration optimized for close-range imaging applications. The diagram depicts the optical pathway extending from a proximal subject target 104 through the lenticular array and toward an image receptor sensor 108. This close-range imaging arrangement is designed to facilitate focused image capture of specific subject features by leveraging the optical modulation properties of the lenticules, thereby enhancing spatial resolution and enabling precise feature isolation in near-field contexts.

This a lenticular array configuration optimized for close-range imaging operates as a macro lens configuration, suitable for imaging subjects at very short focusing distances. A true macro lens typically offers a magnification ratio of 1:1 or greater and a minimum focus distance of approximately 30 cm. Within this embodiment, the lenticular key is positioned in close proximity to the subject, allowing for detailed imaging of fine marker features such as micro-textures, surface anomalies, or biometric identifiers.

The optical modulation achieved through the lenticular structure enables the system to isolate and enhance specific visual elements, supporting applications in identity verification, forensic analysis, and micro-scale object tracking. The configuration is particularly effective in constrained environments where high-resolution capture of small or intricate features is required.

By integrating macro-scale lenticular optics with the broader codification framework, the system ensures that even close-range subjects can be represented with authenticity and precision. The resulting lenticular key marker is processed by the digital system to extract, organize, and authenticate the codified optical data, maintaining continuity with the principles outlined in the digital codification architecture.

FIG. 15B illustrates a subject-specific key marker generated using the lenticular array configuration optimized for close-range imaging, as shown in FIG. 15A. The marker reflects distinctive structural features of the subject, captured and encoded through the lenticular system operating at macro-scale focal distances. This configuration enables high-resolution imaging of fine surface details, allowing for precise codification of biometric or symbolic data such as skin texture, micro-patterns, or emblematic identifiers.

By leveraging the optical modulation properties of the lenticules in a macro lens arrangement, the system supports refined feature extraction and marker generation at reduced imaging distances. The resulting key marker serves as a codified representation of the subject, suitable for identity verification, object tracking, and augmented imaging applications. The close-range configuration enhances spatial resolution and enables detailed capture of features that may be inaccessible or indistinct in standard imaging setups, contributing to the broader codification and authentication framework of the lenticular key system.

FIG. 16A illustrates lenticular array combination 135, comprising parallel polarized lenticular array 132 and perpendicular polarized lenticular array 134, positioned between target 104 and image sensor 108. Operating in tandem, these arrays modulate incident light through structured lens geometries, material compositions, and defined spacing to selectively filter and encode directional light attributes.

In one embodiment, the system for generating a substantially non-replicable lenticular key, by configuring a lenticular array to capture multi-angle optical data from a target utilizes polarized lenses in both orientations to enhance directional filtration, image contrast, and marker segmentation fidelity. The perpendicular polarized configuration leverages the magnetic and electric attributes of light, where the magnetic field is parallel to the plane of incidence and the electric field is perpendicular, to induce a polarization effect that alters the color and luminance of the marker. This enhances contrast and enables detection of subtle structural features.

Conversely, the parallel polarization (transverse magnetic or P-polarized light) configuration, where the electric field is parallel to the plane of incidence and the magnetic field is perpendicular, also modulates color and luminance. When used in conjunction, these polarization states expand the system's detection capabilities, enabling multi-dimensional feature extraction and codification.

This dual-array configuration supports the generation of lenticular key markers with enhanced optical fidelity, feeding into the digital codification system. The resulting data stream is optimized for downstream processes including segmentation, recognition, and authentication within the digital framework.

FIG. 16B depicts perpendicular polarized lenticular array 134, a component of lenticular array combination 135, which aligns incident light along a uniform polarization axis. This configuration supports consistent filtering and improves horizontal edge definition across the subject plane.

FIG. 16C presents exemplary key markers generated using perpendicular polarized lenticular array 134 positioned between the light source and target 104 and between the subject and image receptor sensor 108. This dual-stage polarization pathway refines control over reflection and diffraction phenomena, enabling enhanced feature isolation and high-fidelity marker extraction. The perpendicular orientation effectively reduces ambient noise and accentuates subject contours for codification algorithms.

FIG. 16D shows a structural layout of parallel polarized lenticular array 132, a component of lenticular array combination 135. It comprises vertically aligned lenticules configured to modulate light transmission orthogonal to the sensor axis.

FIG. 16E illustrates a key marker generated using parallel polarized lenticular array 132. Here, marker formation depends exclusively on the geometric and refractive properties of perpendicular lenticules. Although polarization filtering is omitted, the design still enables capture of spatially distinctive features, offering a simplified optical pathway suited to general-purpose imaging with moderate fidelity.

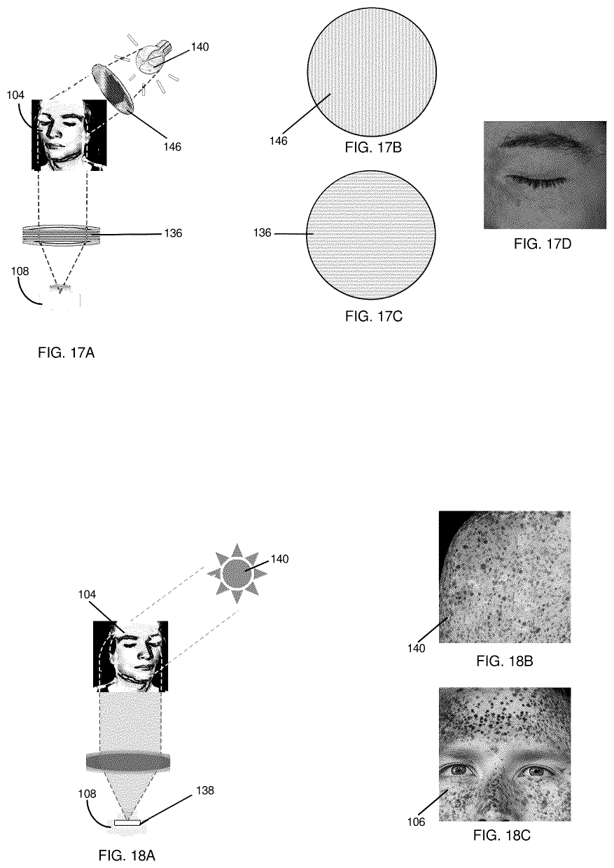

FIG. 17A illustrates a lenticular array configuration in which light source 140 emits light that passes through a cross-polarized vertical lenticular lens 146 and a cross-polarized horizontal lenticular lens 136. These lenticular elements are positioned between light source 140 and target 104, and between target 104 and image sensor 108, respectively. This dual-axis configuration enables polarization filtering along both vertical and horizontal axes, enhancing directional control of incident light and supporting high-fidelity marker generation.

In one embodiment, the system employs two linear polarizers, one at the light source and one at the lens, to implement cross-polarization photography. Vertical and horizontal cross-polarized lenticules are rotated in opposite directions to achieve light extinction, thereby reducing glare and surface reflection. This technique enables detection of encoded visual markers without interference from surface artifacts and enhances capture of subsurface skin features such as vascular patterns, dermal textures, and pigmentation gradients.

The polarization alignment modulates the electric and magnetic field vectors of incident light, altering marker luminance and chromaticity. This improves contrast and feature isolation, particularly in environments with complex lighting or reflective surfaces. When integrated with other lenticular lens types, such as macro, telephoto, or colored lenticules, the cross-polarized configuration expands the system's capacity for multi-layered marker detection and codification. This embodiment supports advanced imaging modalities for biometric authentication, medical diagnostics, and augmented reality applications, and may be further integrated into the digital codification system.

FIG. 17B depicts a vertical polarized lenticule, configured to filter light along a vertical polarization axis. This orientation may suppress horizontal glare and improve vertical edge definition in the captured image.

FIG. 17C illustrates a horizontal polarized lenticule, configured to filter light along a horizontal polarization axis. This arrangement may reduce vertical noise and enhance horizontal contour clarity.

FIG. 17D presents a key marker example produced using the configuration of FIG. 17A in which light source 140 emits light that passes through a cross-polarized vertical lenticular lens 146 and a cross-polarized horizontal lenticular lens 136. The marker reflects encoded visual data derived from the interaction of polarized light with subject-specific features. The use of cross polarized lenticule vertical lens 146 and cross polarized lenticule horizontal lens 136 in tandem allows for multi-axis filtering, improving marker fidelity and enabling robust codification under variable lighting conditions.

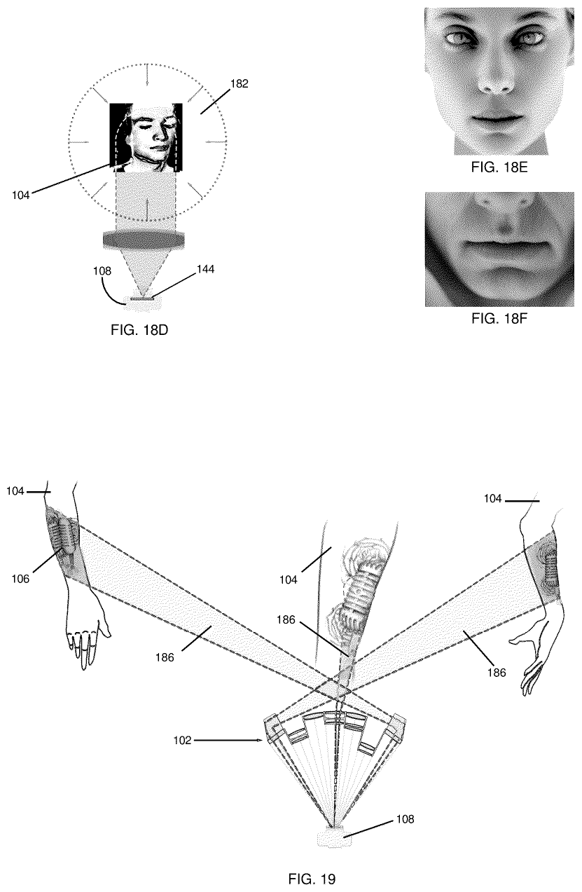

FIG. 18A illustrates a lenticular array configuration in which UV-capable sensor 138 detects light emitted from light source 140 and reflected off target 104, enabling fluorescence-based marker capture under ultraviolet illumination, according to one embodiment of the present disclosure. FIG. 18A illustrates the use of ultraviolet (UV) light technology in conjunction with the lenticular key to enhance marker detection. Light visible to the human eye occupies a spectral range between approximately 400 and 700 nanometers. Ultraviolet light, which falls outside this visible spectrum, occupies a shorter wavelength range between approximately 320 and 400 nanometers. Although UV light is not perceptible to the human eye, it can be captured using specialized film or digital sensors that have been modified for UV sensitivity.

To utilize UV lighting with the lenticular key, a UV light source must be present. This source may include direct sunlight, a specialized flash, or a UV-emitting bulb. In digital photography, the camera or sensor may undergo a full-spectrum conversion to enable UV image capture. When UV light is directed at the subject and passes through the lenticular key, the resulting image reveals enhanced detail in skin markers, particularly those associated with underlying skin conditions.

The use of UV light in combination with the lenticular key provides access to subsurface features and fine skin textures that are otherwise obscured under standard lighting conditions. This technique enables the detection of markers with increased precision and is particularly effective in dermatological analysis and biometric identification.

FIGS. 18B-18C illustrate example key markers produced using a UV light-capable sensor, according to one embodiment of the present disclosure. These markers reflect encoded visual data derived from UV-induced fluorescence and surface reflectivity, enhancing contrast and marker fidelity under ultraviolet conditions.

FIG. 18B illustrates key fluorescence markers detected by UV-capable sensor 138 from target 104, highlighting surface-level features under ultraviolet illumination, according to one embodiment of the present disclosure.

FIG. 18C illustrates additional fluorescence markers captured by UV-capable sensor 138 from target 104, demonstrating spectral variation and marker distribution, according to one embodiment of the present disclosure.

FIG. 18D illustrates a lenticular array configuration in which infrared-capable sensor 144 detects emissions from target 104 illuminated by light source 182, enabling thermal and reflectance analysis under uniform lighting, according to one embodiment of the present disclosure.

FIGS. 18E-18F illustrate example key markers produced utilizing an infrared sensor under an even lighting source, according to one embodiment of the present disclosure. These markers demonstrate the system's ability to resolve infrared-responsive features with high contrast and spatial precision, even under uniform illumination. FIG. 18E illustrates key infrared-responsive markers detected by infrared-capable sensor 144 from target 104 under illumination by light source 182, demonstrating high-contrast resolution of thermal features. FIG. 18F illustrates additional infrared-responsive markers captured by infrared-capable sensor 144 from target 104 under uniform lighting from light source 182, highlighting spatial precision and spectral consistency, according to one embodiment of the present disclosure.

When a sensor or camera is capable of detecting infrared (IR) lighting under controlled lighting conditions, such as uniform or evenly distributed illumination, the resulting image provides an enhanced representation of the external features of the target. The integration of infrared detection technology into the lenticular array enables selective suppression of subsurface features, thereby isolating surface-level marker characteristics. This selective imaging capability allows for the generation of a distinguishable key marker that differs from other markers captured under visible or multispectral lighting conditions. The use of infrared lighting in this context provides an alternative modality for marker differentiation, particularly useful in applications requiring surface feature isolation and high-contrast recognition.

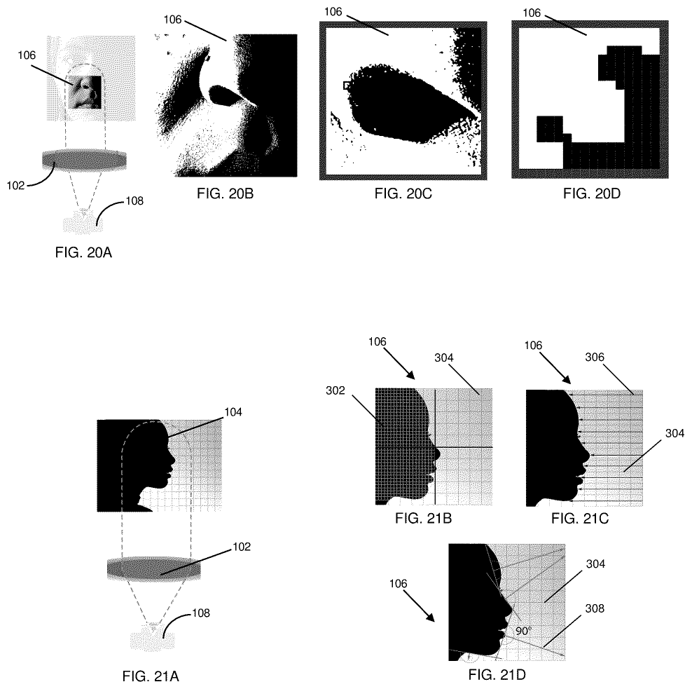

FIG. 19 illustrates a lenticular array configuration in which three snapshots of marker 106 on target 104 are captured as the subject moves across field of view 186, with lenticular/lens array 102 positioned between target 104 and image sensor 108 to enable simultaneous or sequential multi-angle imaging through distinct lenticular elements, according to one embodiment of the present disclosure. Each lenticule or lens within lenticular array 102 is optically aligned to a specific location on the subject and transmits limited visual information from that region to the sensor. As the subject moves, the lenticular array captures discrete views of marker 106, allowing the sensor to record spatially variant data across multiple frames.

The lenticular key provides the sensor with an extensive array of visual components by decomposing a marker from the subject or object and generating a unique key marker that is detectable by the camera or sensor. Detection begins when the subject enters the optical range of the lenticular lenses. For optimal recognition, the subject may be guided along a specific path and positioned under appropriate lighting conditions, with body orientation adjusted to expose the markers.

Once the markers are exposed through the array of lenticules or lenses, the sensor and associated software analyze the individual marker details. These details are passed through each lenticular element and combined to generate a unique visual key. This composite key initiates the codification process, enabling pixel-level tracking, spatial mapping, and post-process alignment of the subject or object.

Now referring to FIGS. 20A-D, another embodiment of the disclosure utilizes the desaturation of markers and high contrast of lighting conditions with detail capture up to the pixel level. FIG. 20A illustrates a lenticular array configuration in which marker 106 is detected using desaturation and/or high contrast image processing, with lenticular array 102 positioned between the marker and image sensor 108 to enhance pixel-level detail capture, according to one embodiment of the present disclosure. Contrasted light enhances the volumetric features of the human body. When detecting highly contrasted images, a lenticular array provides information that can be tracked in time. The detection of markers over time provides the reading of frame sequences that are detectable at the pixel level. When a marker moves, it is refracted/reflected by the lenticular array and captured by the sensor to be recognized as a marker and utilized to create a lenticular key.

As shown in FIG. 20B-D, markers using black and white images or desaturated patterns provide an opportunity to generate custom markers to be detected through the lenticular array. FIG. 20A illustrates a particular lenticular array configuration utilizing desaturation and/or high contrast image detection/processing of the marker. FIG. 20B-D illustrate more key marker examples produced using desaturation and/or high contrast image detection/processing of the marker. FIG. 20B illustrates a high contrast image of marker 106 captured using lenticular array 102, demonstrating volumetric enhancement and spatial clarity under contrasted lighting, according to one embodiment of the present disclosure. FIG. 20C illustrates a pixel-level image of marker 106 produced using high contrast detection via lenticular array 102, enabling refined spatial resolution and marker isolation, according to one embodiment of the present disclosure. FIG. 20D illustrates a time-resolved image sequence of marker 106 captured by lenticular array 102 and image sensor 108, showing refracted motion-based detection for lenticular key generation, according to one embodiment of the present disclosure.

FIG. 21A illustrates a side view of a lenticular array system with optical paths shown as dashed lines, enabling digital detection of silhouetted backlit markers associated with target 104, including pixelated marker 302 positioned within field grid 304 for spatial referencing, according to one embodiment of the present disclosure. FIG. 21A illustrates a lenticular array configuration utilizing a customizable key marker, where lenticular array 102 is positioned to detect spatially relevant features on target 104 under high-contrast lighting conditions, according to one embodiment of the present disclosure. When high-contrast lighting is used to illuminate the subject or object, a measurement field grid pattern placed behind the subject enables the key marker to become measurable as a non-biometric graphic.

FIG. 21B illustrates a silhouetted marker 106 detected behind target 104 using backlighting and lenticular array 102, providing spatial reference for digital measurement, according to one embodiment of the present disclosure. FIG. 21B illustrates a silhouetted pixelated marker 302 detected behind target 104 using backlighting and lenticular array 102, positioned within field grid 304 to provide spatial reference for digital measurement, according to one embodiment of the present disclosure. FIG. 21C illustrates a silhouetted pixelated marker 302 captured in motion across field grid 304, enabling vector-based tracking via vector measurement 308 and temporal analysis of marker silhouette normal displacement and silhouette measurement, according to one embodiment of the present disclosure. FIG. 21D illustrates a profile view of target 104 with pixelated marker 302 showing a 90° angle, enabling angular measurement, horizontal distance to profile 306, and vector measurement 308 within field grid 304, to provide spatial alignment relative to lenticular array 102 and image sensor 108, and referential measurement angles of the target's topology, according to one embodiment of the present disclosure.

FIG. 22A illustrates a lenticular array configuration utilizing a customizable key marker, where lenticular array 102 is directed toward target 104 under high-contrast side light source 140 and dimmed field lighting behind the target 104, according to one embodiment of the present disclosure. The lighting setup allows for the transfer of custom pattern data produced by the extreme lighting conditions in contact with the topology of the target. This configuration allows for the transfer of custom pattern data produced by the extreme lighting conditions, facilitating digital detection and codification of the marker for authentication or alignment purposes. In such instances of high-contrast lighting, target 104 can be positioned or aligned in post-process by computer software that recognizes the tracking points and the marker. FIG. 22B illustrates a digitally layered composite of key marker 106 detected on the hand of target 104 using lenticular array 102, showing overlapping marker layouts for authentication and identification. The key marker becomes a quantifiable object in the spectrum of light, based on black versus white pixel count, line count, and vector direction simplification obtained from the area-specific custom key marker detected within vector tracking points 190A through 190E. In such instances, target 104 can be positioned or aligned in post-process by computer software that recognizes the tracking points and the marker. The key marker shown in FIG. 22B is generated from the high-contrast lighting configuration depicted in FIG. 22A, where lenticular array 102 captures spatially relevant features and transfers custom pattern data. This data is then processed and layered digitally to produce the quantifiable digitally layered composite marker shown in FIG. 22B.

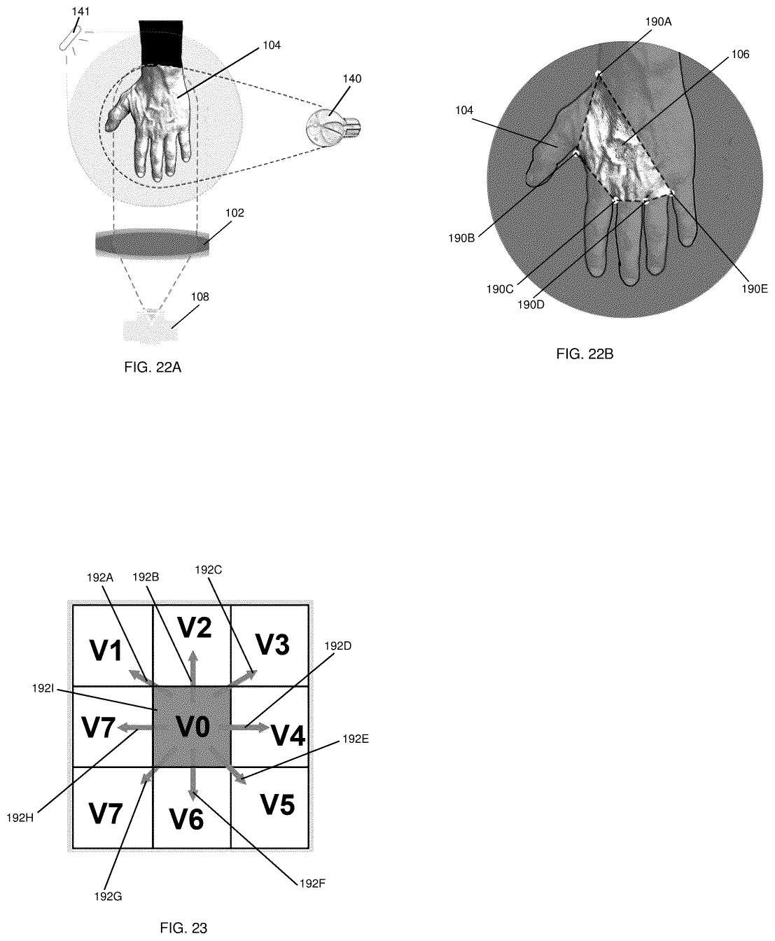

FIG. 23 illustrates a directional grid used by the pixel codification module to track movement of a customizable key marker. The grid is centered around a reference point 250 and is divided into eight directional zones, each corresponding to a specific vector path. These directional zones are labeled V1 through V8 and represent the general discreet vector directions of pixel movement relative to the central point. An additional designation, V0, represents the absence of movement.

The directional vectors are defined as follows: V1 arrow 192A indicates movement toward the upper left, V2 arrow 192B indicates upward movement, V3 arrow 192C indicates movement toward the upper right, V4 arrow 192D indicates movement to the right, V5 arrow 192E indicates movement toward the lower right, V6 arrow 192F indicates downward movement, V7 arrow 192G indicates movement toward the lower left, and V8 arrow 192H indicates movement to the left. V0 box 192I indicates no movement detected.

The codification system utilizes several variables to quantify pixel behavior. The vector (V) represents the direction of pixel movement and is selected from the set V0 through V8. The time (T) variable records the frame index in which movement is detected, such as 0001, 0002, and so forth. Grid coordinates are defined by vertical lines numbered sequentially (e.g., 1, 2, 3) and horizontal lines labeled alphabetically (e.g., A, B, C), allowing for spatial mapping of pixel activity. Pixel status is recorded as either ON (1) or OFF (0), indicating whether the pixel is illuminated.

This vector-based tracking method enables precise monitoring of pixel displacement across sequential frames. The resulting codified data can be used to align the marker during post-processing and to extract vector-based metadata. Additionally, the system may incorporate color filters applied to lenticular elements to expand the codification capacity by introducing spectral differentiation.

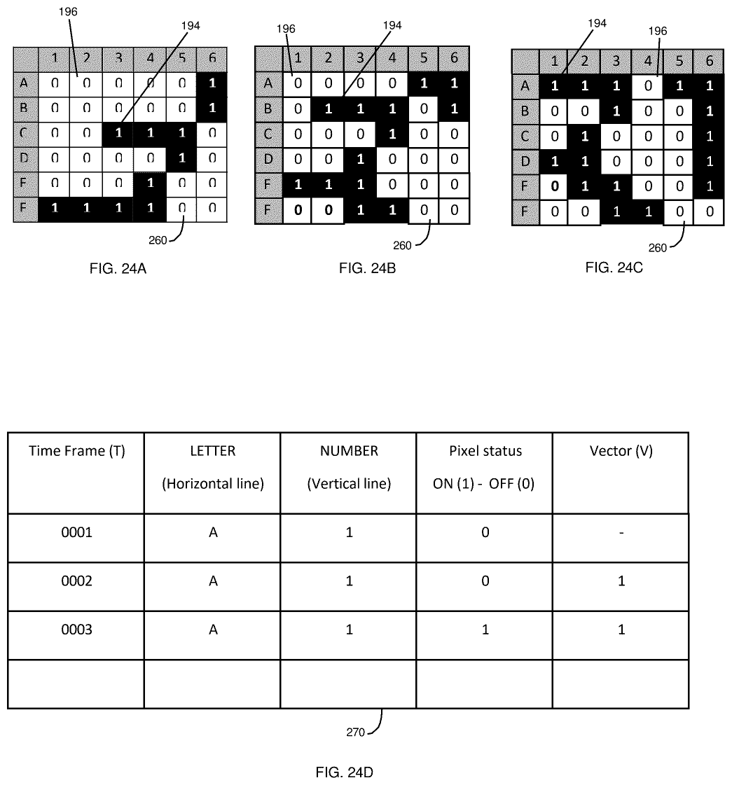

FIGS. 24A through 24D illustrate the pixel-level binary codification and vector tracking of a key marker over time, according to one embodiment of the present disclosure. High-contrast markers at the pixel level generate a binary switch, enabling the system to detect and trace the marker across sequential frames. The marker is analyzed at discrete time intervals (T0001, T0002, and T0003) with the potential to extend the capture duration depending on the frame rate of the camera or sensor and the capabilities of the software application executing the process.

FIG. 24A shows a data organization table 260 representing the initial binary codification of the marker at time frame T0001. Each cell in the table corresponds to a pixel state, with ON pixel 194 and OFF pixel 196 arranged in a grid of rows (A-F) and columns (1-6). At this frame, the ON pixel remains stationary, and the vector movement is designated as V0, indicating no movement.

FIG. 24B presents an alternative binary pattern at time frame T0002, where the ON pixel 194 has moved to the upper left. This movement is codified as vector V1, demonstrating the system's ability to detect directional pixel displacement.

FIG. 24C illustrates a binary pattern at time frame T0003, where the ON pixel 194 continues to move in the same direction, again represented by vector V1. These sequential frames show how pixel movement is tracked and codified using a binary switch and vector designation.

FIG. 24D provides a detailed data tracking table 270 that consolidates multiple dimensions of marker information, including TIME FRAME (T), LETTER (horizontal line), NUMBER (vertical line), PIXEL STATUS (ON=1, OFF=0), and VECTOR (V). This structured format enables the system to track the same ON pixel 194 across sequential frames using a vector-based approach. The movement of the pixel is influenced by refraction or reflection through the lenticular key and is captured by the sensor, allowing the system to recognize and codify the marker's trajectory. This temporal and spatial tracking mechanism supports dynamic marker identification and enhances the robustness of pixel-level authentication. This time-resolved pixel tracking method supports the generation of a unique digital key marker and enhances the system's ability to perform authentication, alignment, and identification based on dynamic pixel behavior.

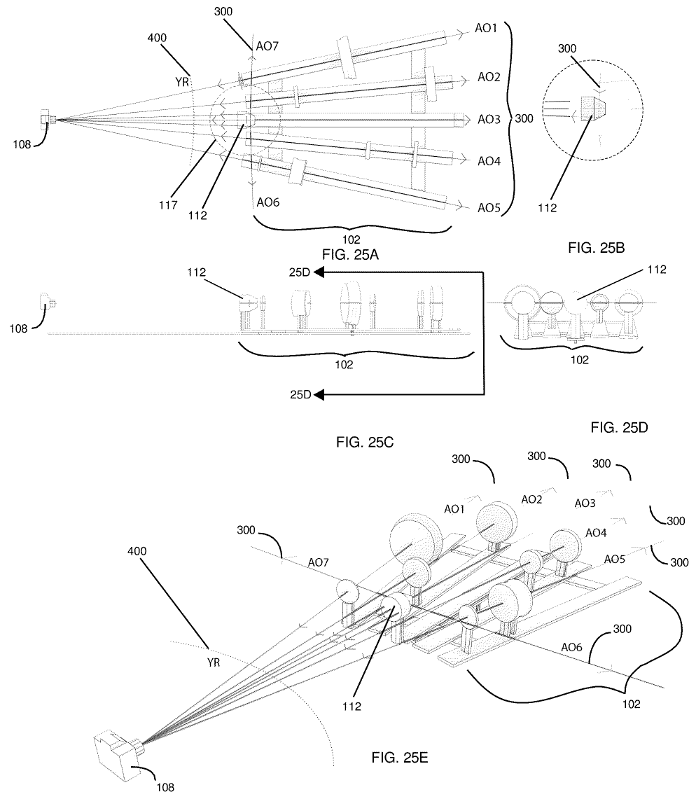

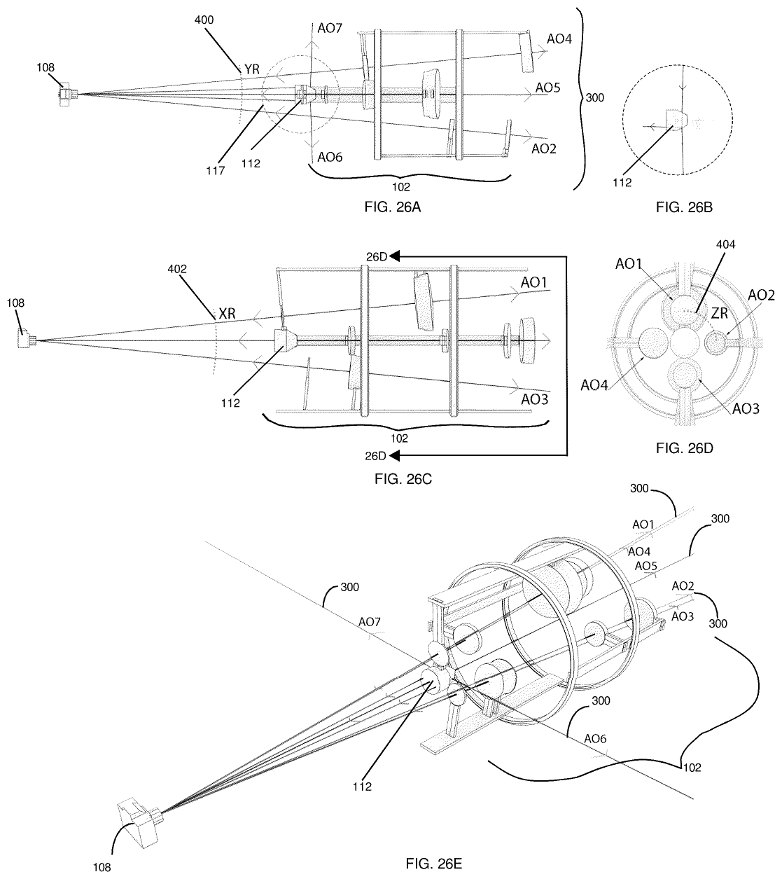

Referring to FIGS. 25A through 26E, the lenticular codification system includes a lenticular array 102 configured to direct light from multiple aiming objectives AO1 through AO7 along defined optical paths 300 toward an image sensor 108. Each optical path 300 represents the trajectory of light and associated data as it passes from a target object through a corresponding lenticule and converges at the image sensor 108. This arrangement facilitates multi-angle imaging, which is essential for generating the lenticular key.

The rotational parameters YR, XR, and ZR are defined as local orientation angles of the lenticular array and its constituent components relative to the camera or sensor, where XR corresponds to the horizontal axis, YR to the vertical axis, and ZR to the depth axis of the camera or sensor. These local angles are dynamically dependent on the spatial positioning of both the camera or sensor and the target object. Each mirror lenticule 112 maintains consistent alignment with the rotational axes XR 402, YR 400, and ZR 404 to ensure precise redirection of incident light along its designated optical path.

FIG. 25A is a top view that illustrates the alignment of lenticular array 102 with image sensor 108, showing how each lenticule channels light along its respective optical path 300. The system is calibrated such that the focal axis of the lenticular array aligns horizontally with the sensor plane, designated by YR 400. This alignment ensures that each lenticule maintains a consistent angular orientation relative to the sensor, optimizing image capture fidelity.

FIGS. 25B through 25E depict orthogonal and perspective views of a linear lenticular array mounted on a structural support. The array includes five lenticular groups configured to provide seven distinct aiming objectives. Each lenticule is spaced to achieve the necessary focal distance, and the structural support ensures mechanical stability while preserving unobstructed optical paths 300.

FIG. 25B is a detailed enlarged view, shown in circle 117 of FIG. 25A, illustrating the structural arrangement along defined optical paths 300 of a dual mirror lenticule 112 within the lenticular array system.

FIG. 25C is a side view of the lenticular array system showing the alignment of components for capturing images. The lenticular array 102 is mounted such that each lenticule 112 is oriented to direct light from its corresponding aiming objective along a defined optical path 300 toward the image sensor 108. The system is calibrated to ensure that the focal axis of the lenticular array aligns horizontally with the sensor plane, designated as YR 400. This horizontal alignment minimizes parallax distortion and ensures that each lenticule maintains a consistent angular relationship with the sensor, thereby preserving the fidelity of captured image data. The side view also reveals the layered configuration of optical components which may be incorporated to enhance light directionality and optimize the resolution of the lenticular key.

FIG. 25D is a front view taken generally along line 25D-25D in FIG. 25C, illustrating the arrangement and configuration of multiple mirror lenticules 112 within the lenticular array 102. This view reveals the lateral distribution of lenticules across the array, each precisely spaced and oriented to direct incident light from distinct aiming objectives along corresponding optical paths 300. The mirror lenticules are configured to reflect or refract light toward the image sensor 108, maintaining consistent angular alignment with the sensor plane designated as YR 400. The front view also highlights the modular grouping of lenticules, which may be organized into discrete clusters to support multi-angle imaging and enhance parallax resolution. Structural supports are visible behind the lenticules, ensuring mechanical stability while preserving unobstructed optical pathways. This configuration enables the system to capture spatially diverse image data necessary for generating a robust lenticular key.

This view emphasizes the spatial configuration and mechanical integration of each lenticule, which is mounted to ensure precise angular orientation relative to the image sensor 108. The mirror lenticules are positioned to direct incident light from distinct aiming objectives AO1 through AO7 along defined optical paths 300. These paths represent calibrated trajectories through which light travels from the target object, reflects or refracts within the lenticule structure, and converges at the sensor plane aligned with YR 400. The structural arrangement ensures that each lenticule maintains its focal integrity and contributes to the multi-angle imaging necessary for generating the lenticular key. Mechanical supports and spacing elements are incorporated to preserve unobstructed optical paths and maintain consistent focal distances across the array.

The lenticular array may incorporate traditional photographic lenses or alternative optical components such as compact lenses, microlenses, Q-type aspheres, or mirror elements. These components are selected to maintain the integrity of optical path 300 across varying focal lengths and sensor distances. Digital processing may further refine the captured data to optimize the lenticular key output.

FIGS. 26A through 26E illustrate an alternative configuration of lenticular array 102 arranged in a circular layout. In this embodiment, mirror lenticule 112 is positioned concentrically around a central axis. Each lenticule is aligned to transmit light along a defined optical path 300 toward image sensor 108.

FIG. 26A shows a top view of the circular lenticular array system, highlighting the spatial relationship between aiming objectives AO1 through AO7 and image sensor 108. Mirror lenticule 112 is configured to redirect light from an off-axis aiming objective toward the sensor, preserving the integrity of optical path 300. The figure depicts the angular orientation of each aiming objective relative to image sensor 108 and central axis YR 400. The system is calibrated such that the horizontal alignment of the array corresponds to reference axis YR 400, ensuring consistent angular orientation across all lenticular groups.

FIG. 26B provides a detailed view of mirror lenticule 112 (shown in circle 113 in FIG. 26A), illustrating its internal structure and reflective geometry. The lenticule maintains consistent alignment with rotational axes XR 402, YR 400, and ZR 404 to ensure accurate redirection of incident light.

FIG. 26C presents a side view of lenticular array 102 with image sensor 108 positioned at a focal distance sufficient to capture light from each lenticule, including those utilizing mirror-based redirection. FIG. 26D is a front view taken generally along line 26D-26D in FIG. 26C, illustrating the circular arrangement of aiming objectives AO1 through AO3. The figure depicts their angular orientation relative to image sensor 108 and axis XR 404. Each lenticule within the array is configured to direct incident light along a defined optical path 300, contributing to the generation of a codified lenticular key.

FIG. 26E offers a perspective side view of the complete system, illustrating the cylindrical arrangement of lenticular groups and the convergence of optical paths 300 toward image sensor 108. The concentric layout facilitates multi-angle imaging and ensures consistent alignment with rotational axes XR 402, YR 400, and ZR 404. The circular configuration includes five lenticular groups that collectively provide seven aiming objectives, incorporating diverging, converging, and mirrored lenses. Mirror lenticule 112 enables redirection of light from peripheral or angular targets, expanding the field of view without compromising alignment. Each lenticule is positioned to maintain a distinct optical path 300, ensuring that light from each AO is accurately transmitted to image sensor 108. The structural support comprises circular rings that hold the lenticular tracks and allow rotational mobility of the lenticular groups. This mobility enables dynamic adjustment of the aiming objectives, thereby modifying the sequence and content of the data captured along optical path 300.

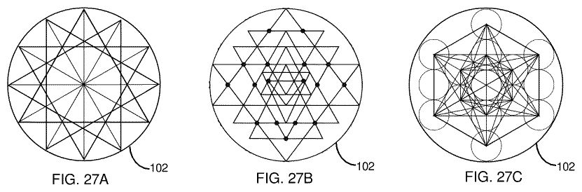

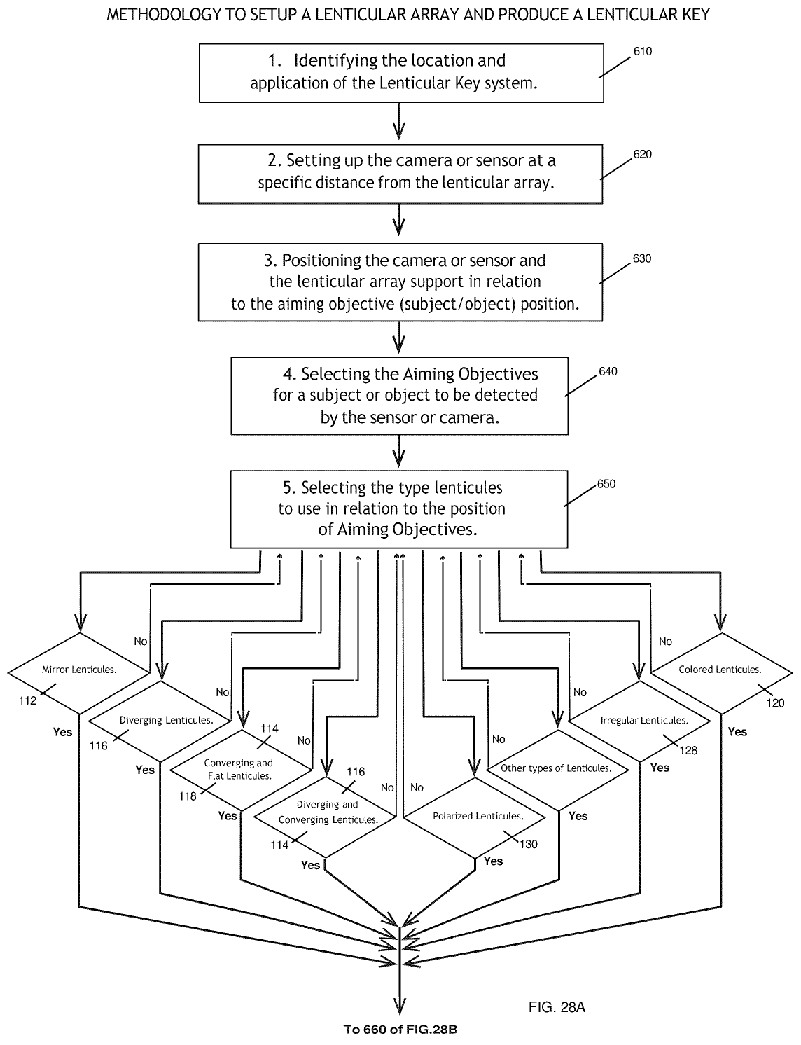

FIGS. 27A-C demonstrate examples of digitally layered key markers, generated through mathematical repetition and temporal capture of visual data. The lenticular key is formed by the interaction between the physical lenticular device and the target features of a subject or object. When a target is captured across multiple time intervals and viewing angles, a substantial number of key markers are produced. These markers serve as discrete data points that can be overlapped and layered to yield increasingly complex datasets.

FIG. 27A illustrates a schematic diagram of a geometric example of a digitally layered key marker configured in a star-like arrangement, according to one embodiment of the present disclosure. FIG. 27B presents an alternative geometric pattern design of a digitally layered key marker, according to one embodiment of the present disclosure. FIG. 27C depicts an intricate layout representing a higher-order spatial organization of a digitally layered key marker according to one embodiment of the present disclosure.

The lenticular array layouts shown in FIGS. 27A-27C may be arranged using mathematically precise positioning or irregular spatial distributions, including regular repeated layouts, irregular layouts, and hybrid combinations. key markers, whether still images or image sequences, captured from a subject/object in motion are positioned according to artificially predetermined array principles, enabling a robust and customizable framework for encoding and retrieving visual data.

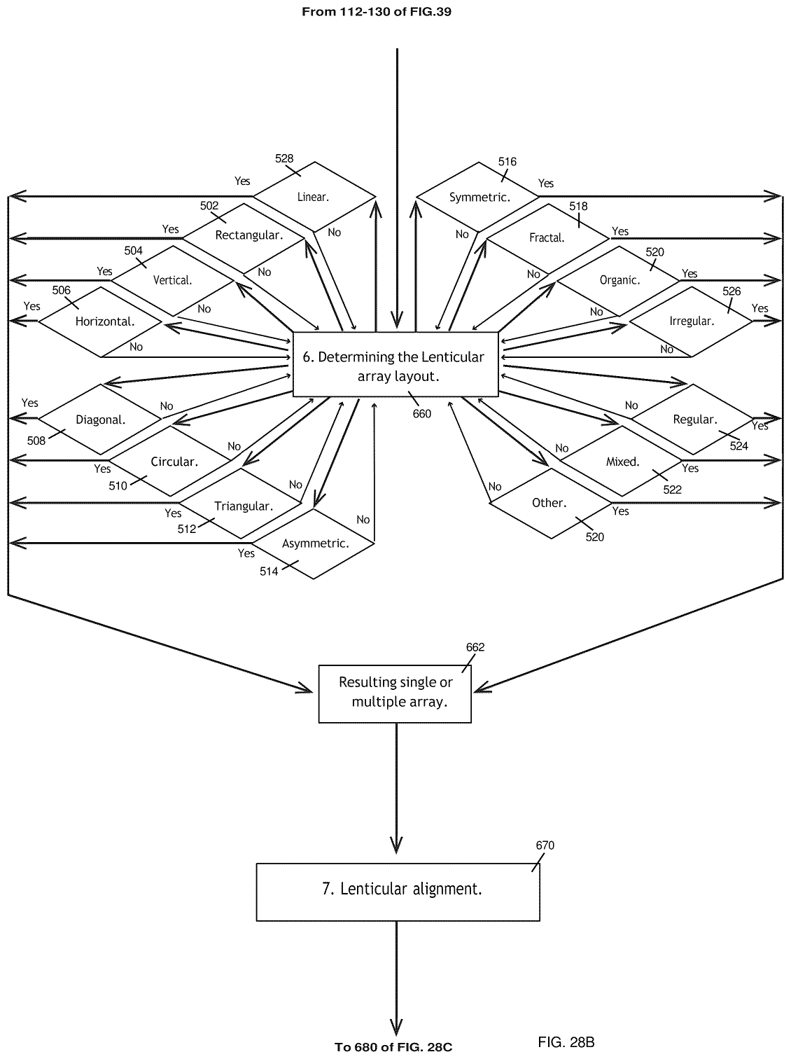

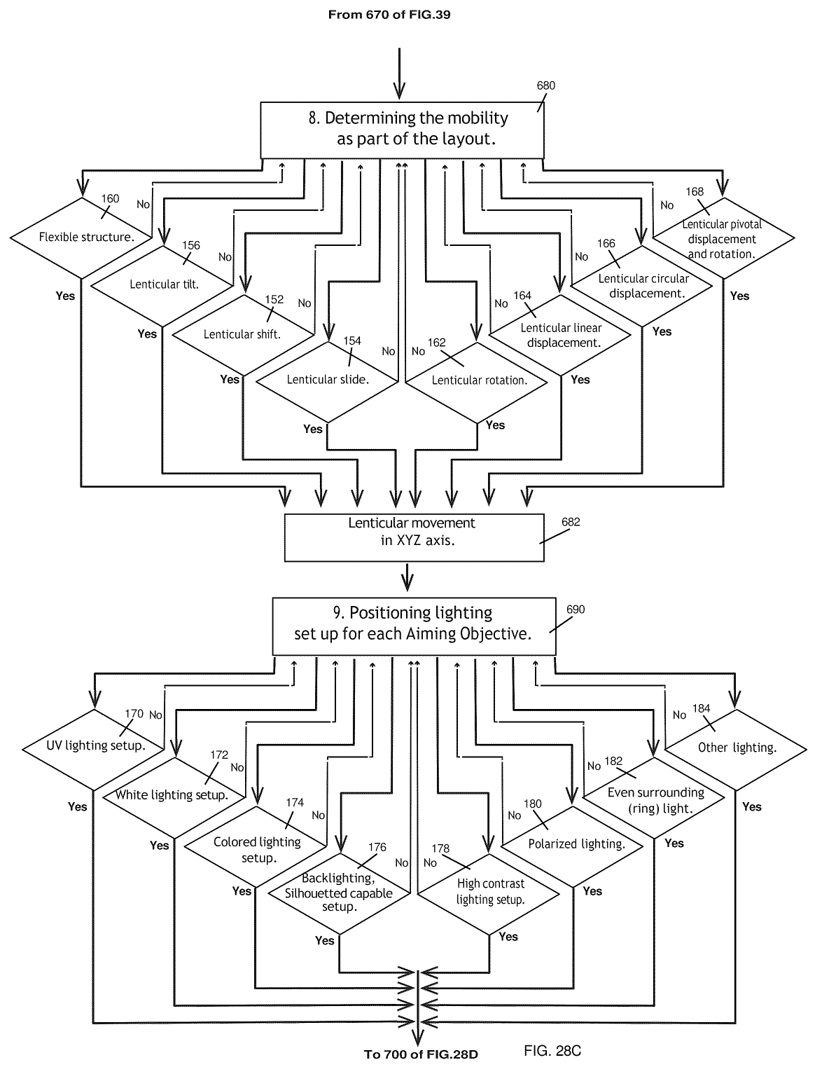

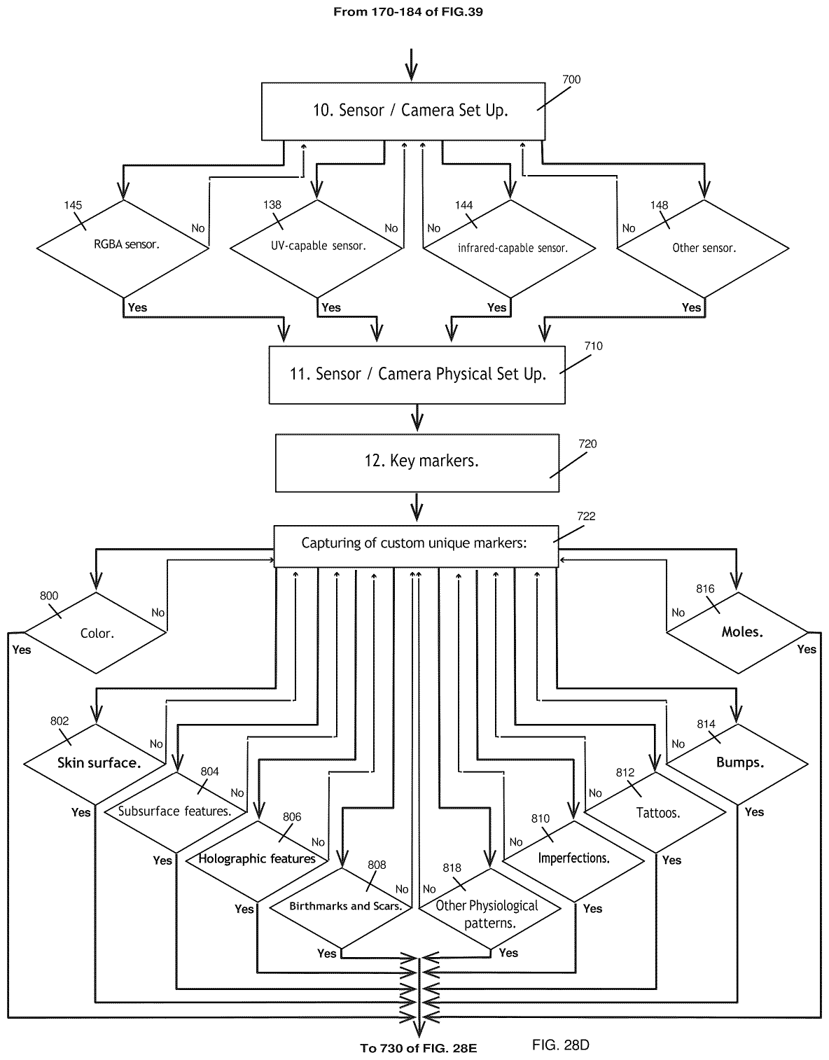

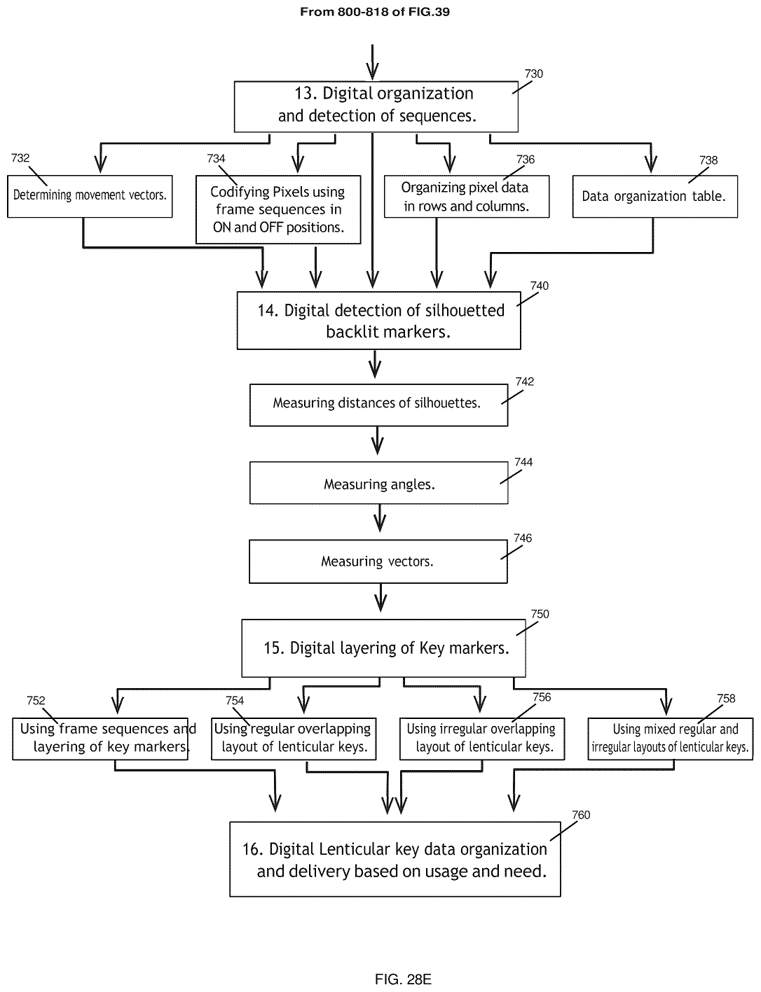

Prior to presenting the procedural steps for the method of generating a substantially non-replicable lenticular key by configuring a lenticular array to capture multi-angle optical data from a target as illustrated in FIGS. 28A-E the following definitions and clarifications of system elements are provided to establish the technical foundation for implementation:

### Digital Codification and Processing of Information

Lenticular technology is based on a physical and mechanical manipulation of light to change color, brightness, shape, volume, sharpness and other physical information from one side of the lenticular apparatus to the opposite side to provide a receiver with a modified or corrected version of the target to facilitate or enhance the perception of the original subject/object in front of the lenticular device. The current method and system expands from that principle and changes the lenticular application, creating a new solution that modifies the output of the optical information. The lenticular array and resulting lenticular key marker utilize the original lenticular principle of light manipulation and apply it to the codification of light data for the camera/sensor to receive a new authentic and irreplicable representation of the target. This information requires a digital system to complement the physical process and receive the lenticular key marker to handle the information, organize it, and derive benefits from the codified optical data. The digital part of the process builds on the information, providing functional attributes not limited to capture, alignment, data analysis, clean up, organization, labeling, storage, querying, retrieval, matching, recognition, identification, authentication, certification of the data.

This system operates as a core component for codifying and processing light and visual data captured by a camera or sensor. The lenticular array, along with the resulting lenticular key, relies on a software application that retains and analyzes the captured information. The software architecture is grounded in pixel-based digital processing and incorporates algorithms for pattern recognition, data discrimination, comparative codification, and structured dataset organization.

Captured image data is parsed into pixel-level components and evaluated across temporal and spatial dimensions to identify marker behavior, movement vectors, and contrast signatures. The system applies binary codification techniques, vector tracking algorithms, and time-resolved analysis to generate a unique digital key marker. This codified output supports applications such as authentication, alignment, and access control, particularly in environments requiring multi-angle imaging and adaptive lens configurations.

### Fundamental Data Representation & Storage:

Pixel Definition: Understanding what a pixel is (picture element), its role as the smallest unit of an image, and how it forms a grid to create a visual representation.

Digital pattern representation is based on grid alignment of squares (pixels) that facilitate the organization of images that can be codified in preprogrammed formats to replicate or store data. Pixel information follows organized patterns that can be the result of lenticular key elements.
Resolution: The total number of pixels in an image (width×height). Higher resolution means more detail but also larger file sizes and processing demands. In a software application that processes lenticular key information, the resolution may vary depending on the type of pattern or data stored. The resolution may vary depending on lenticule information that can provide patterns with high detail, or patterns with lower amounts of detail.
Bit Depth/Color Depth: The number of bits used to represent the color of each pixel.
1-bit (black and white)
8-bit (256 shades of gray or 256 indexed colors)
24-bit (True color: 16.7 million colors, 8 bits each for Red, Green, Blue)
32-bit (True color+alpha channel for transparency)

Higher bit depths mean more accurate color but larger file sizes.

The use of bit-depth with a lenticular key provide the flexibility of working with different patterns offered by the lenticular key. In cases where patterns are high contrasted black and white, 1-bit images are highly functional. 24-bit provides access to color images, as well as patterns that can be used by separating Red, Green, and Blue patterns to store information not only limited to color. This applies to examples such as melanin, filtering of color, hemoglobin key patterns, etc.

32-bit or higher bit-depth images provide opportunities to create multi-layered levels of information. Other examples may be but are not limited to Red, Green, Blue, and Alpha, or hue, saturation, value, contrast, reflectivity, etc.

### Color Models:

RGB: Most common for displays, representing colors as a combination of Red, Green, and Blue intensities.
Grayscale: Represents shades of gray.
CMYK: Used for printing (Cyan, Magenta, Yellow, Black).
HSV: Hue, Saturation, Value, often used for color manipulation.
Alpha Channel: For transparency/opacity, allowing images to blend with backgrounds.
File Formats: Choosing appropriate formats (JPEG, PNG, GIF, TIFF, BMP, etc.) based on compression needs (lossy vs. lossless), transparency support, and specific application requirements. Such formats provide the variability of bit-depth used in a lenticular key pattern.

### Compression:

Lossless: Preserves all original data (e.g., PNG, TIFF). Which provide larger file sizes.
Lossy: Discards some data to reduce file size (e.g., JPEG). Smaller file sizes, but some quality loss.

Both compressions are variable in the process of a lenticular key image to store the proper type of information and provide the needed capacity to retain pattern pixel details.

It is important to highlight that the above technical features of digital imaging are utilized in an unique way in the current disclosure. Since the lenticular key is formed by an array of patterns, the variable features provide alternatives to enhance codification of Lenticular Key subject/object data, making the Lenticular Key segmented in patterns that use some features, while others use different ones.

### Processing & Manipulation:

### Basic Image Transformations:

Geometric Transformations: Rotation, scaling (enlarging/reducing), translation (moving), flipping, cropping are essential postprocess in the manipulation of Lenticular Key patterns. The raw patterns captured through the physical Lenticular array, may be adjusted to make the codification more precise.
Point Operations: Brightness adjustment, contrast enhancement, gamma correction (modifying individual pixel values) are post-processes that will ensure the precision or correction of the data when capturing data through the Lenticular Key array.
Filtering: Applying mathematical operations to pixels and their neighbors for effects like blur, sharpen, edge detection, noise reduction, color selection, polarization enhancements provide additional opportunities to integrate digital filters with physical filters used in the Lenticular Key array.
Color Manipulation: Adjusting hue, saturation, applying color filters, color balancing are post-processes that enhance the results passed through the Lenticular array.
Image Segmentation: Dividing an image into multiple segments or objects is a fundamental feature of the physical Lenticule

### Algorithms for Data Analysis and Discrimination of Patterns

The primordial source of data provided by the Lenticular Key to the camara or sensor corresponds to pixel based information. Such unstructured information generates several variables to process the data through the use of algorithms suited for the type of information.

The variables include but are not limited to distributed processing, streaming algorithms, and memory-efficient techniques. Additionally, other factors such as noise and outlier data require algorithms with robust planning to prevent source errors, processing missing values, and unusual data points. In cases of missing data, imputation and removal are essential to correct inconsistencies and clean up the information to enhance the validation processes. Redundancy of data points will need to be corrected to avoid skewed results, process inefficiencies, or failed validation. To prevent imbalance classification of data techniques such as oversampling and undersampling, and cost sensitive learning are essential.

The lenticular array, and its lenticular key source is made of several data groups as a result of the combination of all the techniques explained above. Capturing, processing, and discriminating the data require relevant algorithms enough to process the large amount of data points, but avoiding high dimensionality that makes pattern detection difficult or impossible to process.

When implementing supervised learning algorithms to process lenticular key variables, it is fundamental to use labeled data to predict a categorical label to the patterns. Unsupervised learning can be applied in lenticular key source information for clustering, reduction and anomaly detection. It is possible to include in the semi-supervised learning in the processing of patterns to train the model through trail an error to understand the variables, and process the key source data.

Neural networks can have a powerful application in the processing of lenticular key data. Its usage of independent nodes provide an opportunity to isolate source patterns of independent lenticules, (a Lenticular Key can be made of four to thousands of lenticules), in such application the separation of nodes and the use of hidden layers allow for a separation of the data which can be only verified when to complete neural network provides an output made of several sets of isolated data. The compilation of the verified data make a stronger key.

Either using neural networks or machine learning to process lenticular key data require of extensive processes of encryption, and extra measures of security to ensure, privacy and independence of lenticular key results. The usage of artificial intelligence in the process requires that the application of such programs are only functional within the use of each key to ensure the security and reliability of the system. A neural network or machine learning application must be trained to manage only the data set connected to an specific lenticular key.

Processing Visual Data Captured from the Lenticular Key

The array presents a unique set of challenges and considerations for a computer application. The diversity of sources introduces variability that must be accounted for to ensure accurate, robust, and meaningful analysis. Here's the key considerations:

### Source-Specific Data Characteristics:

### Camera/Sensor Type:

Resolution: Different cameras/sensors have vastly different resolutions. When using a camera to capture lenticular key source data, some factors must be considered; sensor size, light sensitivity, color science, camera lenses, additional support. These impact detail, file size, and processing time.
Sensor size: While many manufacturers offer full-frame, APS-C, and Micro Four Thirds sensors, the specific implementation and performance can differ. Larger sensors generally offer better low-light performance and dynamic range.
Sensor Noise: Each sensor type has different noise characteristics (e.g., Gaussian noise, salt-and-pepper noise, shot noise). Algorithms need to be robust to or mitigate these.
Dynamic Range: The range of light intensities a sensor can capture. Low dynamic range can lead to blown-out highlights or crushed shadows. High dynamic range (HDR) images require specialized processing and high sampling imaging formats.
Spectral Response: Different sensors capture different wavelengths (e.g., visible light, infrared, ultraviolet, X-ray). This changes the information content.

### Lighting Conditions:

The lenticular Key requires the used of controlled lighting to provide precise information to the sensor, such qualities of light require a precise definition for each lenticule that captures the subject/object information.
Illumination Levels: Bright daylight may be used in cases of UV light detection, indoor photo lighting techniques provide precise visuals to process, night or dark images are not functional with the lenticular key. Algorithms need to be adaptive to varying brightness between lenticules information.
Shadows and Specularities: Presence of shadows and reflective highlights can obscure features or create false positives.

If a camera is used with a Lens to capture information provided by the Lenticular Key array some other factors are required to be defined.
Lens Distortion: Radial or tangential distortions, especially with wide-angle or low-quality lenses. Calibration might be needed.

### Viewing Angle/Perspective:

Orthographic vs. Perspective Projection: Surveillance cameras often have a perspective view, while some industrial or medical imaging might aim for an orthographic view. This impacts geometric measurements.

### Comparative Codification of Datasets

The process involves systematically assigning codes (labels, categories, themes) to elements within two or more datasets to enable direct comparison and analysis. In the process of codifying and comparing lenticular key data there are several categories of information that are considered to organize and prioritize the information.

The categories of information are divided sections following the specification of the current disclosure. A computer application designed for this purpose needs to consider a wide range of factors to ensure data accuracy, consistency, efficiency, and validity of the information.

### Data Ingestion and Preparation:

Diverse Data Sources & Formats: digital imagery of patterns reproduced by a lenticular array provide sources that range from wide views of the body/shapes of the subject-object to macro close-up information of detail patterns. Other sources of data include wide range captures of the light spectrum including color, UV, Infrared and other sources of visual representation of objects using physical and digital means. Other sources of information include data sets of position, direction, scale, distortion, contrast, movement, time, etc.

Additionally, data sources from the lenticular key are arranged in unique order generated by the intricate and flexible configuration of the physical lenticular array. The configuration of such data makes the digital preparation and organization corresponds accurately to the preparation of the capturing program which is connected to the preconfigured design and changeability of the lenticular array.

### Data Cleaning and Preprocessing:

Normalization: Data normalization corresponds to the type of patterns predetermined to be captured. For example: a lenticule can be prepared to transfer only the silhouette information of a subject/object against a high contrast light. A digital application prepared to receive from a codified lenticule at a precise moment in time will allow the system to normalize the information captured from such lenticule. In case of receiving incorrect or non-accurate information, such data can be separated to cleaned up to make the data set more accurate.
Missing Data: Strategies for identifying and handling missing information (e.g., imputation, flag missing, exclusion).
Outliers/Anomalies: When patterns seen through the lenticule provide a lower picture quality, lens aberrations or distortion, light defects or other type of animalities, it is necessary for the application to remove the incorrect pattern to clean up the detection.
Deduplication: Identifying and removing duplicate records within or across datasets. In cases of multiple detections, involuntary subject mistakes, hardware failures, software failures, it is necessary to have a tool that recognizes the repetition or duplication of data. Double imaging in the case of single detection require the removal of less reliable patterns. In case of sequence detection, there is need of an application capable of reading a range of frame patterns to utilize the information in time.

### Metadata Management:

Source Tracking: The predetermined layout and dynamic mobility of a lenticular array, and the accurate connection of an application to the positioning, light quality, and other physical characteristics of the expected data provide an easier tracking of the pattern for aligning with a database of subjects/objects.
Time Control: Tracking changes to the patterns datasets over time, especially in iterative coding processes is essential to manipulate and organize the pattern detection. Classifying patterns based on frame sequences and pixel tracking are part of the current disclosure. The time control and pixel tracking make use of vectors of pixel movement to classify and understand the patterns.

### Codification Process

Definitions: Allowing users and administrators to define and store comprehensive definitions for all possible patterns. It is important that the user/subject is aware of the type of information that is being stored in the data set. For example, when a user's tattoo is used as a visual pattern. The user must be aware on how the tattoo pattern has become a source of information to be captured through one or more of the lenticules on the array. In similar cases the object subject parts/patterns to be used must be listed as part of the originating data set.
Structure: Patterns may be organized in a lenticular array following a predetermined positioning or layout of lenticules. Such layouts are unique to each array. The hierarchical positioning of lenticules and the type of information they will process physically to the digital sensor will be aligned with the clear structure of the information expected to be interpreted by the digital program modifying the visual.
Code/pattern Relationships: Enabling the definition of relationships between patterns. When source information
   Organization of Data Sets and their Management

Managing visual datasets for a lenticular key system presents unique strategies due to their size, complexity, and specific requirements for querying and retrieving, matching, and confirming across several lenticules that provide extensive variety of data points different from each other, but unifying towards individual subjects/objects.

### Data Storage and Organization:

Volume and Scale: Visual datasets of the subject/object provided by the lenticular array (images, frame sequences, videos, 3D point clouds, and more) are very large. The process requires usage of traditional file formatting (JPEG, PNG, EXR, MP4, FBX, OBJ, STL, DDS) with need of comprehensive storage, and organization.
Distributed Storage: For very large datasets, use cloud storage solutions or distributed file systems that can handle petabytes of data. The lenticular key system may be stored on cloud systems, but such practice may represent risks of overlapping information, or security breaches. It is intended that a lenticular key system work on close environments independently from a wide network to limit the access of unwanted performers. Equally, part of this disclosure the separation of datasets from each Lenticular Key arrays. Still, storage for each system may demand large capacity to save, and store information.
Data Lakes/Warehouses: Consider data lakes for raw, unstructured visual data, and data warehouses for processed, structured data with rich metadata. Lenticular key arrays will provide raw data points that will be processes after they are captured by a camera or sensor. The processing of data points will demand the storage of source information, and processed visual datasets.

### Structure:

Hierarchical Folders: Organize by categories, classes, layout categories, time, vector, dates, camera/sensor IDs, and ultimately matching subject/objects IDs. Consistent Naming Conventions: Standardize file and folder names for easy navigation and automation.
Image/Video-Specific Metadata: Store resolution, capture date, camera model, lens parameters, GPS coordinates, lighting conditions, weather.
Annotation Metadata: Crucial for machine learning. This includes:
Labels/Tags: Object classes (e.g., “tattoo”, “nostril”, “UV pattern, etc”).
Bounding Boxes: Coordinates of rectangular regions around subject/objects patterns.
Segmentation Masks: Pixel-level outlines of objects or regions. (e.g. silhouettes)
Keypoints: Specific points on an object (e.g., facial landmarks, body joints, scars).
Captions/Descriptions: Textual descriptions of the image content for manager usage.
Confidence Scores: For automated annotations.
   Datasets and their Annotations.
Data Versioning: Visual datasets, especially annotated ones, evolve frequently.
Reproducibility: Ensure that specific experiments or model training runs can be precisely replicated with the exact dataset version used.

### Data Ingestion and Pre-Processing:

Ingestion Pipelines: Automated pipelines to bring data from various sources (lighting sets, filters, lenticular arrays, cameras/sensors, manual corrective uploads) into the storage system.
Handling Diverse Formats: Support for common image (JPEG, PNG, TIFF, BMP) and video (MP4, AVI, MOV) formats.
Scalability: Ability to ingest large volumes of data efficiently.

### Processing:

Resizing/Rescaling: Standardizing image dimensions for consistent model input.
Color Space Conversion: Converting between RGB, RGBA, Grayscale, HSV, etc.
Normalization: Adjusting brightness, contrast, and gamma.
Noise Reduction: Applying filters to clean up sensor noise.
Data Augmentation: Artificially expanding the dataset by applying transformations (rotation, flipping, cropping, brightness changes, adding noise, geometric distortions) to improve model robustness and generalization.
De-duplication: Identifying and removing exact or near-duplicate images that may provide false matches.

Since the current disclosure produces visual datasets that are captured in time, the computer application that processes such datasets requires a time management system to allow the detection of key markers to be organized from random time frames. The application may run as a stand-alone system on a device or as part of a network that connects and synchronizes multiple datasets from more than one lenticular array.

Lenticular Key Interaction with the Environment.

The embodiment of this disclosure is a device with the potential to be used in several environments and conditions. Such environments change based on the final application of the Lenticular Key system. Some examples of environments include but are not limited to public, commercial spaces such as stores, shopping centers, banking buildings, transportation centers, sports arenas, and restaurants. Other functionalities may be used in private spaces, such as businesses, offices, warehouses, medical facilities, and government and educational buildings.

Additional usage of the Lenticular Key system may include the application of medical devices, transportation and vehicles, scientific equipment, or security. One more application of the Lenticular Key can be on mobile and wearable devices.

### Systems and Applications.

The present disclosure enables operation with thousands, and potentially millions, of lenticules within a Lenticular Array. This scalability, combined with the temporal modulation and image detection at variable time intervals—as well as the specific attributes detailed throughout this specification—supports the processing of exceptionally large and dynamic datasets. These datasets may be variable in structure and capable of movement, introducing levels of complexity that necessitate advanced computational platforms, including binary and quantum computing systems.

The Lenticular Key system is designed to generate highly sophisticated and variable data sets that establish a connection between a subject or object and its corresponding data. A core objective of the disclosure is to enable such intricate codification of information. This complexity arises from the physical fragmentation of light and imagery through a custom-designed lenticular device. Due to its physical nature and unique configuration, the Lenticular Key resists decoding by adversarial artificial intelligence applications, which lack the contextual and physical access required to interpret the device.

Conversely, the strategic integration of artificial intelligence within the system may enhance its performance by improving the organization and processing of the vast and variable data points, thereby strengthening the overall system architecture.

### Method to Set Up a Lenticular Array and Produce a Lenticular Key

The current invention and the method to use a physical device in combination with a digital process solve the need for a system that transfers physical information, modifies optical data, reorganizes and codifies information, matches results, authenticates, and confirms data. The output of such a method is a “Key” that can be used by other applications to grant or restrict access to users to an environment or system. The objectives of this method include, but are not limited to:
a. Creation of complex irreplicable information from a source target.
b. Generate a physical, non-digital source code that is non-repeatable by a digital system only.
c. Provide redundant data points of information.
d. Use variable structural attributes to generate safe, unique systems.
e. Provide data security.
f. Diversify the methodology to authenticate a subject/object.

When planning a lenticular array system, several steps are involved. The process includes a preparation stage of the process in which a specific output need is established, a physical location is confirmed and studied, an analysis of light sources is identified, electrical power is arranged, location and facilities are arranged, other architectural and mechanical considerations are solved, computing and network systems are defined, wiring and hardware are identified, and engineering and technicians prepare floor plans and cad data to provide a blueprint for the execution of the system. As presented in the current invention, every lenticular array system and application requires a unique plan to fulfill the needs and objectives of each location. Multi-location design of a lenticular key system is possible and requires a methodical planning of physical and digital infrastructure.

The execution of the method demands a process that follows precise implementation of the plan. The positioning of devices and target locations requires facilities and execution of physical hardware to support the placement of the system, and the interaction with the subjects/objects, targets of the system, and their traffic flow through the architectural space. The setup of the system requires physical and digital mounting of the apparatus and all its components. Depending on how many lenticular arrays are placed in a space, the system must be arranged to facilitate the proper interaction with users.

The digital setup and software applications that manage the lenticular key system may be located physically at the location where the device is installed or in a remote location as part of a secured information technology network that facilitates its functionality.

FIGS. 28 A-E comprise a flow chart showing the method for generating a substantially non-replicable lenticular key, by configuring a lenticular array to capture multi-angle optical data from a target using the following steps:
At step 610, identifying the location and application of the Lenticular Key system.
At step 620, setting up the camera or sensor at a specific distance from the lenticular array.
At step 630, positioning the camera or sensor and the lenticular array support in relation to the aiming objective (subject/object) position.
At step 640, selecting the Aiming Objectives for a subject or object to be detected by the sensor or camera.
At step 650, selecting the type lenticules to use in relation to the position of Aiming Objectives.
a. Mirror Lenticules 112.
b. Converging Lenticules 114 and Flat Lenticules 118.
c. Diverging Lenticules 116.
d. Diverging and Converging Lenticules.
   i. Telephoto capable lenticules.
   ii. Macro capable lenticules.
e. Polarized Lenticules. 130
   i. Parallel 132 and Perpendicular 134.
   ii. Cross Polarized Lenticules Vertical lens 146 and Cross Polarized Lenticules Horizontal lens 136.
f. Color-filtered Lenticules 120.
g. Irregular Lenticules 128.
h. Other types of Lenticules.
At step 660, Determining the Lenticular array layout.
a. Linear 528.
b. Rectangular 502.
c. Vertical 504.
d. Horizontal 506.
e. Diagonal 508.
f. Circular 510.
g. Triangular 512.
h. Asymmetric 514.
i. Symmetric 516.
j. Fractal 518.
k. Organic 520.
l. Irregular 526.
m. Regular 524.
n. Mixed 522.
o. Other layouts 530.
p. Resulting single or multiple array 662.
At step 670, lenticular alignment.
At step 680, determining the mobility as part of the layout.
a. Flexible structure 160.
b. Lenticular tilt 156.
c. Lenticular Shift 152.
d. Lenticular slide 154.
e. Lenticular rotation 162.
f. Lenticular linear displacement 164.
g. Lenticular circular displacement 166.
h. Lenticular pivotal displacement and rotation 168.
i. Lenticular movement in XYZ axis 682.
At step 690, positioning lighting set up for each Aiming Objective.
a. UV lighting source setup 170.
b. White lighting source setup 172.
c. Colored lighting source setup 174.
d. Backlighting, Silhouetted capable setup 176.
e. High contrast lighting setup 178.
f. Polarized lighting 180.
g. Even surrounding (ring) light 182.
h. Other lighting 184.
At step 700, setting up Sensor/Camera.
a. RGBA sensor 145.
b. UV-capable sensor 138.
c. Infrared-capable sensor 144.
d. Other sensor 148.
At step 710, physical set up of Sensor/Camera.
At step 720, choosing Key markers.
Capturing of custom unique markers 722:
a. Color 800.
b. Skin surface 802.
c. Subsurface features 804.
d. Holographic features 806.
e. Birthmarks and scars 808.
f. Other Physiological patterns 818.
g. Imperfections 810.
h. Tattoos 812.
i. Bumps 814.
j. Moles 816.
At step 730, digital organization and detection of sequences.
a. Determining movement vectors 732.
b. Codifying Pixels using frame sequences in ON and OFF positions 734.
c. Organizing pixel data in rows and columns 736.
d. Data organization table 738. At step 740, digital detection of silhouetted backlit markers.
e. Measuring distances of silhouettes 742.
f. measuring angles 744.
g. Measuring vectors 746.
At step 750, digital layering of Key markers.
a. Using frame sequences and layering of key markers 752.
b. Using regular overlapping layout of lenticular keys 754.
c. Using irregular overlapping layout of lenticular keys 756.
d. Using mixed regular and irregular layouts of lenticular keys 758.
At step 760, digital Lenticular key data organization and delivery based on usage and need.

The present disclosure contemplates that many changes and modifications may be made. Therefore, while the presently-preferred form of the system has been shown and described, and several modifications and alternatives discussed, persons skilled in this art will readily appreciate that various additional changes and modifications may be made without departing from the spirit of the disclosure, as defined and differentiated by the following claims.

What is claimed is:

1. A method for setting up a lenticular array, the method comprising:
setting up a lenticular array at a specific distance in front of a target;
selecting an aiming objective on the target to be detected by an image receptor;
positioning the image receptor and a lenticular array support in relation to the selected aiming objective;
selecting at least two lenticules from the lenticular array to use in relation to the position of the aiming objective;
determining a layout for the lenticular array, wherein the selected layout for the lenticular array includes at least one array with lenticule alignment between the image receptor and the aiming objective;
rotating the lenticular array along X-Y-Z axes within the layout using a mobility mechanism;
providing a light source for the aiming objective; and
setting up at least one of a red-green-blue alpha sensor, an ultraviolet-capable sensor, an infrared-capable sensor, and other sensors.

2. The method of claim 1, wherein the layout for the lenticular array is selected from the group consisting of linear, rectangular, vertical, horizontal, diagonal, circular, triangular, asymmetric, symmetric, fractal, organic, irregular, regular, mixed, and other layouts.

3. The method of claim 1, wherein the mobility mechanism provides for lenticule adjustment operations including at least one of lenticular tilt, lenticular shift, lenticular slide, lenticular rotation, lenticular linear displacement, lenticular circular displacement, and lenticular pivotal displacement.

4. The method of claim 1, wherein the light source is selected from an ultraviolet (UV) lighting setup, a white lighting setup, a colored lighting setup, a backlighting setup, a silhouetted lighting setup, a polarized lighting setup, an even surrounding ring lighting setup, and other lighting setups.

5. The method of claim 1, wherein the ultraviolet-capable sensor captures ultraviolet specific markers on the object/subject under an ultraviolet light source.

6. The method of claim 1, wherein the infrared-capable sensor captures infrared specific markers on the target under an infrared light source.

7. A method for producing a lenticular key, the method comprising:
capturing a plurality of image sequences using a lenticular array positioned between an image sensor and an object/subject;
wherein the capturing uses a red-green-blue alpha sensor, an ultraviolet-capable sensor, an infrared-capable sensor, or other light sensors;
selecting at least one key marker on the object/subject;
analyzing the at least one key marker across the plurality of image sequences to determine lenticular key data including movement vectors and ON/OFF pixel frame sequences, organizing the lenticular key data in a database; and
generating a lenticular key based on the lenticular key data.

8. The method of claim 7, further comprising:
detecting at least one silhouetted backlit key marker on each captured image; and
layering digitally the key markers for analyzing any changes in the key markers across the captured images.

9. The method of claim 8, wherein the analyzing of the at least one silhouetted backlit key marker includes a measuring of distances, angles and/or vectors of the silhouetted backlit key marker across the plurality of image sequences.

10. The method of claim 8, wherein the digital layering of key markers further includes using a regular overlapping layout of key markers, using an irregular overlapping layout of key markers, and/or using mixed regular and irregular overlapping layouts of key markers.

11. The method of claim 7, wherein the at least one key marker is a quantifiable object from the group consisting of the spectrum of light, black vs. white, pixel count, line count, vector direction, and/or area within the plurality of image sequences.

12. A lenticular array system, the system comprising:
a target having at least one key marker;
an image receptor placed in front of the object/subject, the image receptor configured to capture a plurality of images of the at least one key marker;
a lenticular array positioned between the object/subject and the image receptor,
the lenticular array having a plurality of lenticules organized in a specific order for providing a substantially non-replicable representation of the key marker,
wherein the lenticular array is comprised of a combination of at least one of the following groups:
a diverging lenticule, a series of diverging, flat and converging lenticules, a telephoto capable lenticule, a macro capable lenticule, a polarized lenticule, a parallel and perpendicular lenticule across the polarized lenticule, a colored lenticule and an irregular lenticule;
wherein an organization of lenticules into the lenticular array follows a pre-determined layout where all lenticules are aligned forming a unified lens structure;
a support grid configured to provide structural support around each lenticule to ensure the proper alignment of the lenticules;
at least one mobility mechanism providing for the mechanical adjustment of at least one lenticule;
wherein an aiming objective is characterized by the alignment of the lenticular array for viewing and detecting the at least one key marker by the image receptor;
a field grid image processing assembly operationally coupled to the lenticular array, the field grid image processing assembly configured to process the captured images;
wherein the field grid image processing assembly further comprises a pixel codification module and a storage module;
wherein the pixel codification module tracks the at least one key marker across captured images using a vector approach to recognize pixel movement; and
wherein the field grid image processing assembly is configured to generate a lenticular key based on the recognized pixel movement.

13. The system of claim 12, wherein the image processing assembly generates a silhouette from the target within each captured image;
wherein the at least one key marker is determined based on an analysis of each silhouette, and wherein the lenticular key is created based on an analysis of changes in the silhouettes across captured images.

14. The system of claim 12, wherein the at least one key marker is selected from the group including skin color, veins, bumps, moles, tattoos, skin surface, imperfections, holographic features, subsurface features, birthmarks, printed images, clothing and scars.

15. The system of claim 12, wherein the image receptor is a camera and/or a sensor, and wherein the lenticular array has at least one converging lenticule, and one flat lenticule.

16. The system of claim 12, wherein the lenticular array also comprises a lighting set up, a red-green-blue-alpha sensor, an ultraviolet-capable sensor, an infrared-capable sensor, and other sensors; and wherein the unified lens structure is a sheet connecting all the lenticules in a single device.

17. The system of claim 16, wherein the lenticular array also includes color filters to expand the capacity to codify information detectible from the captured images.

18. The system of claim 12, wherein the pixel codification module is configured to codify pixel movement over time with a pre-determined vector across a plurality of consecutive frames of captured images.

19. The system of claim 12, wherein the at least one key marker is refracted/reflected by the lenticular array and is captured by the image receptor.

20. A lenticular codification system comprising:
a target as a subject and/or an object;
a plurality of lenticules arranged into a lenticular array,
a lenticular key as a device for digital codification of the target;
wherein the system enables capturing of a plurality of images of the target through the lenticular array, and
wherein the captured images are digitally analyzed to produce the lenticular key.

21. A system for detecting and processing customizable key markers, comprising:
a lenticular array positioned between a target and an image sensor;
a lighting source configured to illuminate the target with high-contrast lighting;
wherein the target includes a customizable key marker comprising pixelated regions, line segments, and vector tracking points;
wherein the image sensor captures the key marker through the lenticular array; and
wherein the key marker is quantifiable based on at least one of black versus white pixel count, line count, vector direction, and area-specific features.

22. The system of claim 21, wherein digitally layered frame sequences and overlapping layouts of the captured key marker are used to generate a composite representation.

23. The system of claim 21, wherein the key marker is recognized by computer software and used to align the target in post-processing.

24. The system of claim 21, wherein the lenticular array enables detection of silhouetted backlit key markers, and supports spatial measurements including horizontal distance, angular orientation, and vector tracking.

25. The system of claim 21 claim, wherein a lenticular key is generated based upon a detected change in the key marker across a plurality of captured frame sequences.
